(19) United States
(12) Patent Application Publication
(10) Pub. No.: US 2004/0037597 A1
(43) Pub. Date: Feb. 26, 2004

(54) Magnetic core and magnetic field shield member,and excitation coil, transformer, electric equipment, and electrophotographic apparatuses using the magnetic core and the magnetic field shield member

(75) Inventors: Shigehiko Haseba, Nakai-machi (JP); Yasuhiro Uehara, Nakai-machi (JP); Kazuyoshi Itoh, Nakai-machi (JP); Yasutaka Naito, Nakai-machi (JP); Kanji Oka, Nakai-machi (JP); Motofumi Baba, Nakai-machi (JP); Hideaki Ohara, Nakai-machi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/607,171

(22) Filed: Jun. 27, 2003

(30) Foreign Application Priority Data
Aug. 20, 2002 (JP) 2002-238939

(51) Int. Cl. G03G 15/20

(52) U.S. Cl. 399/328; 219/216

(57) ABSTRACT

A magnetic core as a magnetic material that acts on an electromagnetic characteristic of the generated magnetic field and a magnetic field shield member that shields the magnetic field generated by magnetic field generation unit are structured such that magnetic particles are arranged in a base material under a dispersed state. As a result, a magnetic core in which an inductance can be set and a magnetic field shield member in which magnetic field leakage can be suppressed effectively, as well as an excitation coil, a transformer, electric equipment and an electrophotographic apparatus using them are easily provided at low costs.

### FIELD OF THE INVENTION AND RELATED ART STATEMENT

The present invention relates to a magnetic core and a magnetic field shield member, and an excitation coil, transformer, electric equipment, and an electrophotographic apparatus using the magnetic core and the magnetic field shield member. In particular, the invention related to a magnetic core suitably used for an inductance element such as a coil or a transformer with a magnetic substance installed to produce an electromagnetic characteristic, and a magnetic field shield member, and an excitation coil, a transformer, electric equipment and an electrophotographic apparatus using them.

An excitation coil or a transformer of an inductance element is one of important parts of electronic machines and electric appliances as a part having inductance. An excitation coil is formed by winding a coil around a magnetic core and is generally known as an electromagnetic. On the other hand, a transformer is formed by winding two or more coils at different positions of a magnetic core. In recent years, electronic machines such as mobile telephones, PHS, and portable computers are being sophisticated, miniaturized, and manufactured at low costs. Thus, there arises a demand for high performance, miniaturization, and low manufacturing costs of excitation coils and transformers which are parts used in the electronic machines.

In many cases, the size, performance, and cost of an excitation coil or a transformer are determined by a magnetic core used for the coil or the transformer. If a material having large effective magnetic permeability is used as a magnetic core material, the self-inductance and mutual inductance of the excitation coil or the transformer can be increased and accordingly, parts thereof can be miniaturized. In the excitation coil or the transformer, the loss quantity as represented by the Q value of inductance is a parameter directly involved in the energy efficiency of the excitation coil or the transformer, and the excitation coil or the transformer having a large Q value, namely, a small loss quantity is assumed to be have good performance.

Hitherto, a silicon steel plate and a ferrite sintered compact have been used as magnetic core materials of excitation coils and transformers. Since a metal material such as a silicon steel plate generally has large conductivity, if the metal material is localized in a changing magnetic flux to increase conductivity, an eddy current occurs to cause heat generation, namely, so-called eddy-current loss occurs. Thus, when using a metal material as a magnetic core, the magnetic core has a structure in which several silicon steel plates each formed of thin metal material are stacked, thereby preventing the eddy-current loss.

With such silicon steel plate, the loss increases in a high-frequency band. Thus, in the high-frequency band, a ferrite sintered compact of a metal oxide material is used in place of the silicon steel plate.

However, the ferrite sintered compact has the disadvantages that it is not easy to be worked into any desired shape, that it is also poor in flexibility, and that it is expensive. Consequently, use of a composite material in which ferrite particles are dispersed in resin has been proposed. The composite material can be provided as a material which is flexible and is also comparatively small in loss. However, it is small in magnetic permeability and thus is not satisfactory as a magnetic core material.

As the magnetic core of an excitation coil or a transformer, a plurality of portions, such as an E-shaped core and an I-shaped core, may be joined to form one magnetic core. In this case, if only a minute gap is to exist, it is comparable to the fact that magnetic circuit is largely cut. This is because due to the gap, the magnetic characteristic of the magnetic core is deteriorated and a magnetic field leakage occurs, causing an unnecessary electromagnetic field leakage. An excitation coil or a transformer is installed in various electric appliances; in recent years, when designing various electric appliances, it is becoming necessary to consider the effect of the magnetic flux leaked from such electric appliances on a human body.

By the way, as image formation technique, electrophotography has become widespread because it provides many merits such as high print speed, convenience of eliminating the need for providing a print plate each time, and capability of providing images directly from various pieces of image information. In addition, there are merits that the apparatus is small-sized, can easily provide a full-color image, and the like.

An image formation apparatus (electrophotographic apparatus) adopting electrophotography generally forms an electrostatic latent image on the surface of a latent image bearing body, brings charged toner into contact with the surface of the latent image receptor to selectively deposit the toner to form a toner image, and transfers the toner image to a record medium via or not via an intermediate transfer body and then fixes the toner on the surface of the record medium by heat and/or pressure, etc., thereby providing an image.

In such an electrophotographic apparatus, usually a fusing device including a heating roll and a pressurizing roll abutting each other is used for fixing. A record medium on which an unfixed toner image is formed is inserted into a nip part formed by the heating roll and the pressurizing roll abutting each other, whereby the toner is fused by heat and pressure and is fixed on the record medium as a permanent image. A heating member and a pressurizing member shaped like an endless belt may be used in place of the heating roll and/or the pressurizing roll. The heating roll includes a metal core containing a heat source such as a halogen lamp, the metal core being formed with an elastic layer and a mold release layer, and the heating roll surface is heated internally by the heat source.

In the fusing device, it is desired to instantaneously heat the heating member such as the heating roll, etc., and lessen the wait time (warm-up time) as much as possible from the viewpoint of energy saving and the viewpoint of preventing the user from waiting when using the image formation apparatus. However, with the fusing device adopting a heating roll containing a heat source such as a halogen lamp, there is a limit to shortening the warm-up time for the reasons that it takes a considerable time in heating the halogen lamp itself, that it takes time until heat propagates to the surface because heat is generated from the inside of the heating roll, that it takes time in heating the entire heating roll because a heating roll core having a considerable heat capacity must be selected, and the like. If a halogen lamp is used as the heat source, so-called flicker phenomenon occurs in which an energization current flows transiently when the halogen lamp is turned on or off; this is also a problem.

In recent years, as a heating unit used in the fusing device, unit using an electromagnetic induction heating technique is being studied in place of the heat source such as a halogen lamp (JP 2000-242108 A). In the technique, a magnetic field generated by a magnetic field generation member is made to act on a heating member having a conductive layer, whereby the heating member is heated by the electromagnetic induction action; the problem of flickering is not involved and only the heating object can be heated instantaneously, so that the warm-up time can be shortened.

The electromagnetic induction heating technique can be applied to any of a roll-shaped member such as a heating roll or a pressurizing roll, or a member shaped like an endless belt replacing either or both of the heating roll and the pressurizing roll as the heating member. With the roll-shaped member, only the vicinity of the surface contributing to fixing may be heated and the core need not be heated, so that energy saving can be accomplished. On the other hand, the member shaped like an endless belt is thin and thus has a small heat capacity and can accomplish energy saving of a still higher order.

The electrophotographic apparatus may adopt not only the technique of fixing a record medium to which an unfixed toner image is transferred from a latent image receptor or an intermediate transfer body by a separate fusing device as described above (which will be hereinafter simply referred to as “transfer and fixing independent technique” in some cases), but also a transfer and fixing simultaneous technique of bringing the unfixed toner image formed on an intermediate transfer body into contact with a record medium while heating, and applying pressure, thereby performing transfer and fixing at the same time (JP 49-78559 A, etc.,). In the transfer and fixing simultaneous technique, adoption of the electromagnetic induction heating technique in transferring and fixing is also proposed for a similar reason to that in the transfer and fixing independent technique (JP 8-76620 A, JP 2000-188177 A, JP 2000-268952 A, etc.,).

As described above, in the electrophotographic apparatus, adoption of the electromagnetic induction heating technique is considered, but the electromagnetic induction heating technique involves the magnetic field generation member as the main constituent for heating. Therefore, in the magnetic field generation member in the electrophotographic apparatus, of course, it is also desirable that the eddy-current loss should be suppressed, thereby accomplishing still more energy saving at low cost. In recent years, miniaturization of the electrophotographic apparatus is underway, and in the electrophotographic apparatus adopting the electromagnetic induction heating technique for fixing or transferring and fixing, it is desirable that the flexibility of the shape of the magnetic core is enhanced to expand the flexibility in designing the apparatus and in addition, that the apparatus should be further miniaturized.

As a hold member (bobbin) having the function of a magnetic core that is applied to a magnetic field generation member (coil) adopting the electromagnetic induction heating technique, a hold member obtained using a ferrite sintered compact is disclosed in JP 2001-312164 A. The ferrite sintered compact is excel in heat resistance property but has the disadvantages that it is high-priced, that it is not easy to work to any desired shape, and that it is poor in formability.

Further, since the electrophotographic apparatus is installed in an office, etc., it is desirable that leakage of a magnetic field from the magnetic field generation member should be prevented so as not to affect various machines installed in the proximity of the electrophotographic apparatus and to protect the human bodies against the effect of the magnetic field. Thus, it is desirable that a member capable of shielding the magnetic field from the magnetic field generation member still more effectively should be adopted as a magnetic field shield member installed in the periphery of the magnetic field generation member.

As a magnetic field shield member that shields a magnetic field generated from a magnetic field generation member adopting the aforementioned electromagnetic induction heating technique, a magnetic field shield member made of a non-magnetic metal material having good conductivity is proposed in JP 09-325629 A. In more detail, there is proposed a magnetic field shield member made of a single metal that is any one of aluminum, copper, silver, and gold or an alloy containing at least one of aluminum, copper, silver, and gold. However, the metal material has large conductivity, so that when a magnetic member is produced using such a metal material, if the metal material is localized in a changing magnetic flux, an eddy current occurs and heat is generated, which causes an eddy-current loss.

Aside from this, a construction where a ferrite sintered compact that is a metal oxide material is used to produce a magnetic field shield member is proposed in JP 2000-215974 A. As described in the explanation of the magnetic core, however, the ferrite sintered compact has the disadvantages that it is high-priced, that it is not easy to work to any desired shape, and that it is poor in formability.

### SUMMARY OF THE INVENTION

The present invention has been made in view of the above circumstances and provides a magnetic core which is capable of easily setting inductance at low cost by installing the magnetic core in a excitation coil or a transformer, and a magnetic field shield member capable of efficiently suppressing an electromagnetic field leakage.

Further, the present invention provides an electrophotographic apparatus adopting an electromagnetic induction heating technique for fixing or transferring and fixing, in which a magnetic core suppressing an eddy current loss and having high flexibility in shape is used for a magnetic field generation member, so that still more energy saving can be accomplished at low cost, the flexibility in designing the apparatus can be expanded, and further, the electromagnetic apparatus can be still more miniaturized.

Still further, the present invention provides an electrophotographic apparatus adopting an electromagnetic induction heating technique for fixing or transferring and fixing, in which magnetic field leakage from a magnetic field generation member can be shielded effectively.

In the invention, a material, in which magnetic particles are added to any base material and are allowed to solidify under a dispersed state, is used as a magnetic material that acts on a magnetic core or inductance element constituting an inductance element such as an excitation coil or a transformer. As a result, the electromagnetic characteristic of the excitation coil or transformer is improved and the leakage of an electromagnetic field is suppressed.

In more detail, the magnetic core of the invention is provided so as to be related to at least a part of the magnetic field generation member and is constructed using a material, in which magnetic particles are arranged in a base material under a dispersed state, as a magnetic material acting on the electromagnetic characteristic of a generated magnetic field.

According to the invention, a material, in which the magnetic particles are arranged in the base material under a dispersed state, is used as the magnetic material constituting a magnetic core. Therefore, the magnetic particles can be added to a composition constituting the base material with their particle state maintained and injected into a mold for molding at the time of manufacturing. As a result, merely by selecting the shape of the mold as appropriate, the shape of the magnetic core can be flexibly determined and a magnetic core having a desired shape can be manufactured with ease.

The magnetic core of the invention adopts the magnetic particles as the magnetic core material and the magnetic particles are maintained in the particle state, so that occurrence of the eddy current in the magnetic core can be canceled. Thus, the heat loss due to the eddy current can be canceled.

The magnetic particle includes at least one of iron powder, ferrite powder, and magnetite powder.

The type of magnetic particles is not limited so long as the magnetic particles can maintain the particle state. If powder of at least iron powder, ferrite powder, or magnetite powder, namely, magnetic particles are adopted in a single type or in combination are adopted, the characteristic of the magnetic particles can be set as desired.

No specific limitation is generally imposed on the base material so long as the base material is formed in a matrix. However, it is preferable that there is used a solidified hydraulic composition because this composition generally has an extremely high heat resistance property and therefore the magnetic core obtained using this composition also has an extremely high heat resistance property. In addition, as is represented by an aggregate added as an extending agent, it is generally possible to add a large volume of another component to the hydraulic composition. As a result, in the invention, it is preferable that the solidified hydraulic material is used because it becomes possible to increase the mixing ratio of the magnetic particles and to realize magnetic permeability that the magnetic core is required to possess. That is, if a resin is used as the base material, it is difficult to increase the mixing ratio of the magnetic particles while exceeding a certain level. Therefore, in order to obtain a high-performance magnetic core by further increasing the magnetic permeability, it is preferable that the solidified hydraulic composition is used.

Here, the “hydraulic composition” used in the invention refers to an inorganic material that exhibits hardenability when kneaded with water, that is, an inorganic glue, and examples thereof include various cement and gypsum. In the invention, the hydraulic composition is not specifically limited, although it is preferable that portland cement or a high-density hydrothermal synthetic ceramics precursor is used. Portland cement has the advantages that it is easy to obtain, that it has high strength, that it is low in cost, and the like. On the other hand, the high-density hydrothermal synthetic ceramics precursor has the advantages that it has an extremely high strength, that it is lightweight, and that it has a high size-accuracy. In addition, both of these materials have a high heat resistance property.

A magnetic field shield member according to another aspect of the invention is provided on the periphery of a magnetic field generation member for generating a magnetic field and shields the magnetic field generated by the magnetic field generation member. This magnetic field shield member is characterized by being structured such that magnetic particles are arranged in a base material under a dispersed state.

An inductance element, such as an excitation coil or a transformer, may leak a magnetic field to the outside and this magnetic field leaked to the outside changes depending on the shape or the installation position of the inductance element. In the invention, however, the magnetic field shield member has a structure in which magnetic particles are arranged in a base material under a dispersed state, so that the magnetic field generated by the magnetic field generation member can be shielded efficiently.

The magnetic particle in the magnetic field shield member of the invention is preferably at least one of iron powder, ferrite powder, and magnetite powder.

No specific limitation is generally imposed on the base material so long as the base material is formed in a matrix similarly to the base material of the invention. However, it is preferable that there is used a solidified hydraulic composition because this composition generally has an extremely high heat resistance property. In addition, the composition allows an increase in the mixing ratio of the magnetic particles and to realize magnetic permeability that the magnetic field shield member is required to possess. It is preferable that portland cement or a high-density hydrothermal synthetic ceramics precursor is used as the hydraulic composition.

The excitation coil of the invention is obtained by placing the aforementioned magnetic core of the invention in a coil serving as the magnetic field generation member and/or is obtained by placing the aforementioned magnetic field shield member of the invention on the periphery of the coil serving as the magnetic field generation member. Also, the transformer of the invention is a transformer obtained by winding at least two coils at different positions of one magnetic core, with the magnetic core being the aforementioned magnetic core of the invention and/or the aforementioned magnetic field shield member of the invention being provided on the periphery of at least one of the coils.

In many cases, an element generating a magnetic field is an inductance element such as an excitation coil or a transformer and, by flexibly setting the shape of the magnetic core, it becomes possible to obtain a desired shape of the inductance element. Also, it is possible to flexibly design the shape of the magnetic field shield member in accordance with the shape of the excitation coil or the transformer, which enhances the flexibility of overall design of an apparatus using them. Needless to say, even in this case, the effects unique to the magnetic core and/or the magnetic field shield member of the invention are fully exerted.

Also, the electric equipment of the invention includes at least a magnetic field generation member, and the aforementioned magnetic core of the invention is provided so as to be related to at least a part of the magnetic field generation member and/or the aforementioned magnetic field shield member of the invention is provided in the periphery of the magnetic field generation member. As described above, the flexibility of design of the magnetic core or the magnetic field shield member is high, so that the flexibility of overall design of the electric equipment is also increased. As a matter of course, the effects unique to the magnetic core and/or the magnetic field shield member of the invention are fully exerted and the performance of the electric equipment can also be enhanced.

On the other hand, the magnetic core and/or the magnetic field shield member of the invention can be preferably used with an electrophotographic apparatus adopting an electromagnetic induction heating technique for fixing or transferring and fixing. The specific configurations of the electrophotographic apparatus to be preferably adopted are as follows ((1) and (2)).

(1) An electrophotographic apparatus including: an image formation unit for forming an unfixed toner image on a surface of a record medium by using electrophotography; a fuser unit having a fixing rotation body and a pressurizing rotation body disposed to press against the fixing rotation body to define a nip part therebetween, fixing the unfixed toner image on the surface of the record medium by inserting the record medium into the nip part so that the surface of the record medium on which the unfixed toner image is formed contacts with the fixing rotation body, in which a conductive layer is formed in the proximity of the circumferential surface of one of the fixing rotation body and the pressurizing rotation body, and in which a magnetic field generation member is placed close to one of the fixing rotation body and the pressurizing rotation body to which the conductive layer is formed.

In this case, the magnetic core of the invention can be preferably used in the magnetic field generation member. To shield at least a part of a leakage magnetic field not affecting the conductive layer, of the magnetic field generated from the magnetic field generation member, preferably the magnetic field shield member of the invention is placed in the periphery of the magnetic field generation member. Of course, preferably the magnetic core of the invention is used in the magnetic field generation member and further the magnetic field shield member of the invention is placed in the periphery of the magnetic field generation member. As the shapes of the fixing rotation body and the pressurizing rotation body, a roll-like shape and an endless belt shape may be selected in any desired combination.

(2) An electrophotographic apparatus including: an image bearing rotation body; an image formation unit for forming an unfixed toner image on a circumferential surface of the image bearing rotation body by using electrophotography; a heating member disposed in the image bearing rotation body to abut against the image bearing rotation body within the circumference thereof, and provided for heating the image bearing rotation body (if necessary); and a pressurizing member disposed to face the heating member through the image bearing rotation body to define a nip part with the image bearing rotation body, in which a record medium is inserted into the nip part, whereby the unfixed toner image is transferred and fixed onto a surface of the record medium by application of heat and pressure, in which a conductive layer is formed at least in one of the proximity of the circumferential surface of the image bearing rotation body and the proximity of an abutment part of the heating member against the image bearing rotation body, in which when the conductive layer is formed in the image bearing rotation body, a magnetic field generation member is disposed close to the image bearing support rotation boy in the nip part and upstream thereof of the image bearing rotation body, and in which when the conductive layer is formed in the heating member, the magnetic field generation member is disposed close to the heating member.

Also in this case, the magnetic core of the invention can be preferably used in the magnetic field generation member. To shield at least a part of a leakage magnetic field not affecting the conductive layer, of the magnetic field generated from the magnetic field generation member, preferably the magnetic field shield member of the invention is placed in the periphery of the magnetic field generation member. Of course, preferably the magnetic core of the invention is used in the magnetic field generation member and further the magnetic field shield member of the invention is placed in the periphery of the magnetic field generation member. The image bearing rotation body may be shaped like a roll or an endless belt.

According to the invention, a member, in which magnetic particles are arranged in a solidified hydraulic composition under a dispersed state, is used as the magnetic core, so that the magnetic core can be easily molded to any of various shapes and can be easily manufactured. Also, merely by installing this member in a part of an inductance element such as an excitation coil or a transformer, the inductance can be flexibly designed over a wide range. Further, only a small loss is caused and effective magnetic permeability can be enhanced even in a high frequency band.

Also, according to the invention, magnetic particles that are the main material of the magnetic core are arranged in a base material under a dispersed state with their particle state maintained, so that occurrence of an eddy current in the magnetic core can be canceled. Thus, a heat loss due to the eddy current can be canceled.

Further, the magnetic field shield member of the invention made of a material, in which magnetic particles are arranged in a base material under a dispersed state, is installed in the surroundings of the magnetic field generation member for generating a magnetic field. As a result, an electromagnetic field leakage can be suppressed, the shape can be worked as desired, and the flexibility of parts design can be enhanced. In particular, if a solidified hydraulic composition is used as the base material, it becomes possible to secure a high heat resistance property of the obtained magnetic core or magnetic field shield member and to increase the mixing ratio of the magnetic particles. As a result, it becomes possible to still further enhance the magnetic permeability.

With the excitation coil, transformer, and electric equipment of the invention using the magnetic core and/or the magnetic field shield member of the invention having the superior effects described above, effects achieved by the adopted magnetic core and/or magnetic field shield member of the invention can be given to the excitation coil, transformer, and electric equipment, as a matter of course. Also, the flexibility of design of the excitation coil, transformer, and electric equipment itself can be significantly enhanced.

On the other hand, according to the invention, an electrophotographic apparatus adopting an electromagnetic induction heating technique for fixing or for transferring and fixing is provided in which a magnetic core that suppresses an eddy current loss and has high flexibility in shape is used for a magnetic field generation member. With this construction, still more energy saving can be accomplished at low cost, the flexibility in designing the apparatus can be expanded, and the electromagnetic apparatus can be still more miniaturized.

Also, according to the invention, an electrophotographic apparatus adopting an electromagnetic induction heating technique for fixing or for transferring and fixing is provided which is capable of effectively shielding a magnetic field leakage from a magnetic field generation member.

### BRIEF DESCRIPTION OF THE DRAWINGS

FIG. 1 is a front view of an excitation coil (excitation coil that is an example of the invention) to which a magnetic core according to a first embodiment of the invention is applied;

FIG. 2 is a front view of an excitation coil (excitation coil that is another example of the invention) to which a magnetic core that is a modification of FIG. 1 is applied;

FIG. 3 is a characteristic drawing showing relationship between applied signal frequencies and inductance for both a case where a coil core (magnetic core) is contained and a case where no coil core is contained;

FIG. 4 is a schematic drawing showing a magnetic field shield member according to a second embodiment of the invention;

FIG. 5 is a schematic sectional view showing a transformer according to a third embodiment of the invention;

FIG. 6 is a schematic drawing showing an electrophotographic apparatus according to a fourth embodiment of the invention;

FIG. 7 is a schematic drawing showing only a portion of a fusing device of the electrophotographic apparatus shown in FIG. 6;

FIG. 8 is a schematic drawing showing only a portion of a fusing device of an electrophotographic apparatus according to a fifth embodiment of the invention;

FIG. 9 is a perspective view showing positional relationship between a heating roll and a magnetic field generator in the fifth embodiment;

FIG. 10 is a schematic drawing showing only a portion of a fusing device of an electrophotographic apparatus according to a sixth embodiment of the invention;

FIG. 11 is an enlarged sectional view showing a part of a heat belt used in the fusing device in the sixth embodiment;

FIG. 12 is a structural drawing showing the support structure of the heat belt used in the fusing device in the sixth embodiment;

FIG. 13 is an explanatory drawing showing the heating principle of the heat belt used in the fusing device in the sixth embodiment; and

FIG. 14 is a schematic drawing showing an electrophotographic apparatus according to a seventh embodiment of the invention.

### DETAILED DESCRIPTION OF THE PREFERRED EMBODIMENTS

Referring now to the accompanying drawings, there are shown preferred embodiments of the invention in detail.

[First Embodiment]

To begin with, a first embodiment concerning a magnetic core of the invention that can be used as an inductance element and can realize high magnetic permeability easily and at low cost will be discussed.

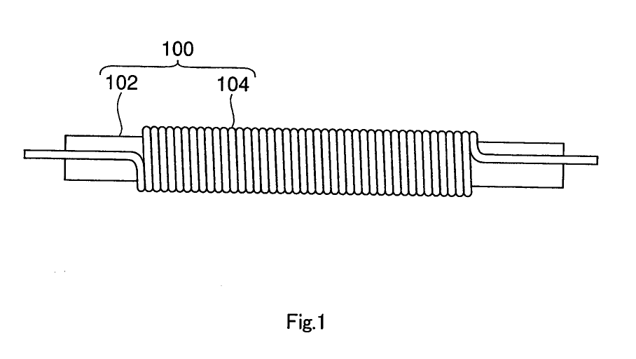

FIG. 1 is a front view of an excitation coil (excitation coil of the invention) that uses the magnetic core of the invention. This excitation coil 100 is produced by winding a coil 104 around a hold member 102 that is generally referred to as the “bobbin”. The magnetic core of the invention is applied to this hold member 102.

That is, the hold member 102 has a structure in which magnetic particles are arranged in a base material in a dispersed manner. Here, the magnetic particles and the base material that are the characteristics of the invention will be described in detail below.

(Magnetic Particles)

The magnetic particle includes particulate matter having a reasonable particle diameter in addition to fine powder. That is, the particle diameter can be selected in a wide range from an extremely minute particle diameter to a generally large particle diameter of iron waste material, etc. Specifically, any can be selected from among particles having particle diameters in a wide range of 0.1 μm to 1 mm. However, the lower limit of the particle diameter is preferably 1 μm or more, and more preferably, 5 μm or more from the viewpoint of availability, fluidity, handleability, etc. Likewise, the upper limit of the particle diameter is preferably 500 μm or less, and more preferably, 200 μm or less.

The shape of the particle is not particularly limited and any shape can be selected. For example, a spherical shape, a needle shape, a clot shape, a flat shape, a porous shape, an indeterminate shape, or the like, or a mixture of the shapes can be named. Among them, the spherical shape is preferred from the viewpoint of availability and fluidity.

As the magnetic particles, specifically, iron powder, ferrite powder, and magnetite powder can be named as preferred particles, and one of them may be used singly or a plurality of them may be mixed for use. By using magnetic particles of a single type or a combination of plural magnetic particles, flexibility in specifying the characteristics of the magnetic particles can be achieved.

For example, as the magnetic particles, industrial magnetic particles can be used. Specifically, for example, iron powder carrier and ferrite carrier for electrophotography made commercially available by Powdertech Co., Ltd. are preferred. As the iron powder carrier, reduced iron powder, atomize iron powder, cutting waste, etc., or iron powder provided by crushing cuttings and adjusting the particle degree, or oxide film iron powder coated with an extremely thin oxide film of iron can be named. Resin-coated iron powder in which surfaces of the iron powders mentioned above are respectively coated with resin to adjust the electric resistance is also known. As the ferrite carrier, soft ferrite typified by MOₐ.M′O_{b}(Fe₂O₃)ₓ (where M and M′ indicate metal elements and a, b, and x indicate integers), for example, powdered ferrite of Ni—Zn ferrite, Mn—Zn ferrite, Cu—Zn ferrite, etc., can be named.

As other magnetic particles, iron powder for powder metallurgy, iron powder for shot, iron powder for deoxidant, iron powder for body warmer, iron powder for chemical reduction, iron powder for welding electrode, iron powder for powder cutting, iron powder filled in deoxidant, any other rubber, or plastic, and the like can be named.

In the invention, molding is performed by adding the magnetic particles into a hydraulic composition with the particle state thereof maintained, inserting a mixture of the magnetic particles and the hydraulic composition into a mold or the like, and allowing the hydraulic composition to solidify. Here, the expression “particle state maintained” means a state in which the magnetic particles are physically independent of each other as particles, and does not include a state where the magnetic particles are melted due to heating or the like and each particle state is lost.

As the magnetic particles in the invention are used for the material of the magnetic core, it is desirable that magnetic particles having the following magnetic property and electric property are selected.

<Magnetic Property>

Saturation magnetization is in a range of 10 to 500 emu/g

Remaining magnetization is 15 emu/g or less

Coercive force is 500 e or less

Relative permeability is 2 to 200

<Electric Property>

Electric resistance is 10⁸O cm or more (when voltage of 250 V is applied)

Using the magnetic particles exhibiting these behaviors to form a magnetic core, for example, the magnetic core is installed in a part of a coil or a transformer as an inductance element and the magnetic and electric characteristics can be adjusted in the target range. Further, when using the magnetic particles, the magnetic material is maintained in a particle state and generation of the eddy current can be eliminated.

In the magnetic core of the invention, the mixing ratio of the magnetic particles is not specifically limited and may be determined within a range of 90% or less (0<x=90, the upper limit is equal to or less than 90%, while the lower limit is determined by an inductance value and therefore it is sufficient that the lower limit is at least equal to 0%) in accordance with characteristics that the magnetic core is required to possess. In the magnetic core of the invention, when a solidified hydraulic composition to be described later is used as the base material, it becomes possible to increase the mixing ratio of the magnetic particles. Therefore, in this case, it is preferable that the mixing ratio of the magnetic particles is set in a range of 60 to 90% on a volume ratio basis, and more preferably in a range of 65 to 75%.

In this embodiment, there is used iron power carrier TSV-35 manufactured by Powdertech Co., Ltd. The characteristics of this iron power carrier TSV-35 are as follows.

Particle size: 45 to 75 (μm)

Current value: 20 to 75 (μamp)

Saturation magnetization: 170 to 195 (emu/g)

Resin coat: not provided

(Base Material)

Generally, no specific limitation is imposed on the base material applied to the invention so long as the base material is in a matrix. Therefore, the base material is appropriately selected from among materials having a flowing state to which the magnetic particles can be added with the particle state of the magnetic particles maintained and which can be injected into a mold for molding. For example, as the material of the base material, it is possible to adopt resin materials used as “binding resins” in various fields, as a matter of course. In addition, it is possible to adopt any other material having the functions described above regardless of whether the material is an organic material or an inorganic material. Among these, a hydraulic composition has superior advantages that it is easy to mold, that it is low in cost, that it has a high heat resistance property, and the like, and therefore is particularly suited as the material of the base material. In this embodiment, the hydraulic composition is used as the material of the base material.

Any material may be used as this hydraulic composition so long as the material is so-called inorganic glue, and all materials called “hydraulic cement” in a broad sense may be used. To be more specific, for example, it is possible to name portland cement, alumina cement, silica cement, pozzolan cement, fly ash cement, roman cement, blast furnace cement, hydraulic lime, gypsum, and the like. In the invention, no specific limitation is imposed on the hydraulic composition, although it is preferable that the hydraulic composition is portland cement or a high-density hydrothermal synthetic ceramics precursor. Portland cement has the merits that it is easy to obtain, that it is easy to form a material having a high strength, and that it is low in cost. On the other hand, high-density hydrothermal synthetic ceramics made of the high-density hydrothermal synthetic ceramics precursor has the merit that it is high in size accuracy because it is extremely high in strength and hardly suffers from drying shrinkage. A compact obtained through the solidification of the hydraulic composition generally has a high heat resistance property and, as a matter of course, these two preferable substances also have a high heat resistance property.

As portland cement used as the hydraulic composition, it is possible to cite various portland cement such as ordinary portland cement that is generally used as well as high-early-strength portland cement, ultra high-early-strength portland cement, moderate-heat portland cement, high-iron-oxide-type portland cement, and sulfate-resistant portland cement, each of which can be suitably used in the invention. Also, there occurs no problem even if a well-known additive is added to the cement.

The additive and formation method that are usable when portland cement is used as the hydraulic composition are the same as those in the case of the high-density hydrothermal synthetic ceramics precursor to be described later. It is easy to grind and work a substance obtained by allowing the high-density hydrothermal synthetic ceramics precursor to solidify, although a cement compact obtained by allowing portland cement to solidify is not generally suited to grinding work. It is sufficient that various conditions, such as the water-to-cement ratio, are appropriately selected in accordance with the purpose within the category of a well-known use method.

The high-density hydrothermal synthetic ceramics precursor used as the hydraulic composition is made of a hydraulic pulverulent body, a non-hydraulic pulverulent body, and a workability improving agent, with various additives being added thereto as necessary. The high-density hydrothermal synthetic ceramics precursor is converted into high-density hydrothermal synthetic ceramics through molding by pressurizing, hydrothermal synthesis, machining, and surface processing, with the machining and surface processing being performed as necessary. The various additives to be added as necessary refers to additives to be added and mixed for the purpose of reinforcement, quantity increase, formability improvement, water repellency, and the like. Therefore, for example, an aggregate or the like to be added and mixed for the purpose of the reinforcement and quantity increase may be added as necessary.

Here, the “hydraulic pulverulent body” refers to a pulverulent body to be hardened by water and examples thereof include a calcium silicate compound pulverulent body, a calcium aluminate compound pulverulent body, a calcium fluoroaluminate compound pulverulent body, calcium sulfoaluminate compound pulverulent body, calcium aluminoferrite compound pulverulent body, calcium phosphate compound pulverulent body, hemihydrate or anhydrous gypsum pulverulent body, a quick lime pulverulent body having a property of self hardening, and a mixture pulverulent body made of at least two of these pulverulent bodies. As a representative thereof, a pulverulent body of the aforementioned portland cement can be given, for example.

As to the particle degree distribution of the hydraulic pulverulent body, it is preferable that the Blaine specific surface area is at least equal to 2500 cm²/g because it is required to secure hydraulic performance concerning the strength of the compact. Also, in the high-density hydrothermal synthetic ceramics precursor, the compounded amount of the hydraulic pulverulent body is set in a range of 50 to 90 mass %, with the total amount of the hydraulic pulverulent body and the non-hydraulic pulverulent body being 100 mass %, although it is preferable that the compounded amount is set in a range of 65 to 75 mass %. When the compounded amount is less than 50 mass %, the strength and filling ratio are lowered. On the other hand, when the compounded amount exceeds 90 mass %, there is lowered the filling ratio with which the compact is obtained. In either case, there is a danger that properties after molding and hardening may be changed (lacking may occur at the time of machining, for example) and the size stability is adversely affected, which means that these cases are not preferable.

The “non-hydraulic pulverulent body” described above refers to a pulverulent body that will not be hardened even when contacting water under a state where this body is not mixed with another body. Here, the non-hydraulic pulverulent body contains pulverulent bodies whose component flows out under an alkaline or acid state or in a high-pressure steam atmosphere and reacts with another component that has already flowed out to form a product. When such a non-hydraulic pulverulent body is added, it becomes possible to increase the filling ratio at the time of formation of the compact, to decrease the void ratio of the obtained compact, and to enhance the size stability of the compact.

As a representative of the non-hydraulic pulverulent body, a calcium hydroxide powder, gypsum powder, calcium carbonate powder, slag powder, fly ash powder, silica stone powder, clay powder, silica fume powder, and the like, may be given. The average particle diameter of these non-hydraulic pulverulent bodies is preferably set equal to or less than 1/10 of the average particle diameter of the hydraulic pulverulent body, and more preferably equal to or less than 1/100 thereof. On the other hand, it is not specifically required to set the lower limit of the particle diameter so long as no deleterious influence is exerted on the effect achieved by a product that is finally obtained.

In the high-density hydrothermal synthetic ceramics precursor, the compounded amount of the non-hydraulic pulverulent body is set in a range of 10 to 50 mass %, with the total amount of the hydraulic pulverulent body and the non-hydraulic pulverulent body being 100 mass %, although it is preferable that the compounded amount is set in a range of 25 to 35mass %. The influence exerted when the compounded amount falls outside of this range has already been described in the explanation of the compounded amount of the hydraulic pulverulent body. Accordingly, when consideration is given to machinability and the like, it is preferable that the compounded amount of the non-hydraulic pulverulent body is adjusted so that the filling ratio will never be lowered too much.

The “workability improving agent” described above refers to a material having a property that contributes to the improvement in formability, mold release property, cutting/grinding property, and grinding accuracy of a compact obtained from the hydraulic composition, in particular to the improvement in cutting/grinding property and grinding accuracy. That is, by adding the workability improving agent, the formability of a mixture made of the hydraulic composition is improved because the workability improving agent plays a role as a molding aid at the time of molding by pressurizing. Also, the brittleness of a cement-based hardened body is improved by the workability improving agent, which makes it possible to strip an obtained compact without damaging the compact at the time of the stripping. As a result, workability is improved. Further, a compact obtained from the hydraulic composition that is generally a brittle material exhibits a cutting state based on a “crack-type” mechanism at the time of cutting. However, by adding the workability improving agent, it becomes possible to prevent cracking or lacking (containing microscopic phenomena) of the material during cutting, to improve the workability of the compact obtained from the hydraulic composition to the level of metal materials, and to perform cutting work using a lathe or the like and to perform grinding work using a cylindrical grinder or the like in the same manner as in the case of a metal material. It becomes possible to perform the work described above, so that it becomes possible to perform precise work in the order of μm with reference to a desired size.

As an example of the workability improving agent, a powder or emulsion made of at least one resin selected from among vinyl acetate resin, vinyl acetate-acryl copolymer resin, vinyl acetate-Veova copolymer resin, vinyl acetate-maleate copolymer resin, vinyl acetate-ethylene copolymer resin, vinyl acetate-ethylene-vinyl chloride copolymer resin, acryl-styrene copolymer resin, acryl-silicon copolymer resin, and an epoxy resin may be given.

In the high-density hydrothermal synthetic ceramics precursor, the compounded amount of the workability improving agent is set in a range of 2 to 18 parts by mass on a dry base when the mixture pulverulent body of the hydraulic pulverulent body and the non-hydraulic pulverulent body has 100 parts by mass, although it is preferable that the compounded amount is set in a range of 5 to 15 parts by mass. When the compounded amount is less than 2 parts by mass, the grinding workability is degraded. On the other hand, when the compounded amount exceeds 18 parts by mass, the grinding accuracy is lowered and the size stability after grinding is also lowered. Consequently, it is not preferable that the compounded amount falls outside of the range.

The particle degree of the workability improving agent is generally set equal to or less than 1 μm on the basis of the diameter of a single particle under a dispersed state. In order to manufacture the high-density hydrothermal synthetic ceramics, a mixture for molding is prepared by mixing water and the above-mentioned magnetic particles into a mixture pulverulent body (high-density hydrothermal synthetic ceramics precursor) made of the hydraulic pulverulent body such as portland cement, the non-hydraulic pulverulent body such as silica fume, the workability improving agent such as the acrylic resin, and another additive. Here, the amount of the mixed water is set at 30 parts by mass or less with reference to 100 parts by mass of the mixture pulverulent body made of the magnetic particles, the hydraulic pulverulent body, and the non-hydraulic pulverulent body or is set less than the theoretical amount of hydration. It is preferable that the mixing is performed by using a mixing method or a mixing machine with which it is possible to apply a strong shearing force to the mixture for molding. Also, it is also preferable that the mixture is granulated to a size suited for a mold shape after the mixing. As a granulating method used in this case, it is possible to use a well-known method such as a rolling granulation method, compressing granulation method, a stirring granulation method, a spray dry method, and the like.

The mixture for molding obtained in this manner is molded through molding by pressurizing. Upon molding, a mold having a desired shape is prepared and pressurizing is performed using a hydrostatic press, a multi-axial press, a uniaxial press, or the like. As to the pressurizing conditions in this case, it is preferable that the press pressure is increased so as to approach a calculated theoretical density as much as possible, although its lower limit value greatly varies depending on the easiness of molding of the mixture, the content of water, the size accuracy required, and the like. After the molding by pressurizing, steam curing is performed or steam curing in an autoclave is performed. Note that when there occurs the lack or shortage of water for molding the hardened body, it is preferable that the steam curing is performed in an autoclave.

As an example of the high-density hydrothermal synthetic ceramics (containing no magnetic particle) obtained from the high-density hydrothermal synthetic ceramics precursor used in the invention, it is possible to name “Z-ma” (trade name) commercialized by Sumitomo Osaka Cement Co., and a material obtained by dispersing and fixing magnetic particles therein can be given as a suited example.

The composition of the mixture for molding used in this embodiment is as follows.

Portland cement: 32 mass %

Silica fume: 14 mass %

Acryl resin: 4 mass %

Water: 11 mass %

Aggregate (No. 8): 11 mass %

Magnetic particle: 28 mass % (iron power carrier TSV-35)

Molding by pressurizing is carried out using the mixture for molding, whereby a hold member 102 is produced. The shape of the hold member 102 is set as a cylindrical shape having a diameter of 17 mm? and a length of 360 mm. The mixing ratio of the magnetic particles in the obtained hold member 102 is set at 75% on a volume ratio basis. The hold member 102 has a structure in which the magnetic particles are added into the hydraulic composition while maintaining their particle state and are arranged under a dispersed state.

It should be noted here that the hold member 102 has a cylindrical shape in this embodiment, although the invention is not limited to this and it is possible to select various shapes in accordance with the purpose. For example, it is possible to appropriately select the shape from among an oval cylindrical shape, a rectangular parallelepiped shape, a triangle pole shape, a hexagonal pole shape, or another arbitrary shape in accordance with the usage conditions, installation place, and required magnetic characteristics.

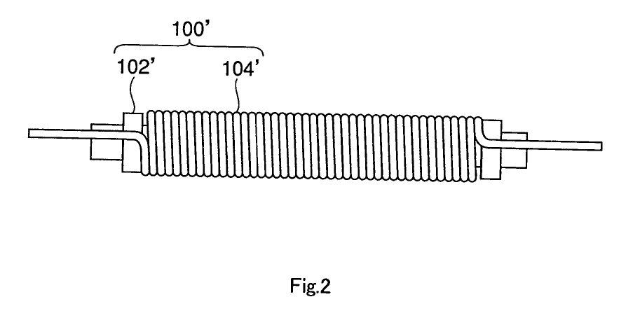

Here, likewise a hold member (magnetic core) 102′ shown in FIG. 2, it is also preferable that a step increasing in diameter at each end portion of a region in which a coil 104′ is wound is provided. With this shape, it becomes easy to wind the coil 104′ and becomes possible to hold the coil 104′ with reliability. It is possible to mold the magnetic core of the invention even to such a complicated shape with ease using a mold having a desired shape. In particular, when a hydraulic composition (in particular, the high-density hydrothermal synthetic ceramics precursor) is used as the material of the base material like in this embodiment, it becomes possible to realize a shape with higher precision through grinding. Here, FIG. 2 relates to a modification of this embodiment and is a front view showing another example of the excitation coil (excitation coil of the invention) to which the magnetic core of the invention is applied. The illustrated excitation coil 100′ has a construction where the coil 104′ is wound around the hold member 102′, with the magnetic core of the invention being applied to this hold member 102′.

In this embodiment, a Litz wire having a bundle of 60 wires with a wire diameter of 0.3 mm is used as the winding of the coil 104 wound around the excitation coil 100, with the number of turns being set at 125. In the manner described above, there is obtained an excitation coil to which the magnetic core of the invention is applied.

As described above, according to this embodiment, it is possible to add magnetic particles to a hydraulic composition while maintaining the particle state of the magnetic particles, to inject a resultant mixture into a mold, and to perform molding at the time of manufacturing. As a result, merely by selecting the shape of the mold as appropriate, it becomes possible to freely set the shape of the magnetic core and to manufacture a magnetic core having a desired shape with ease.

Also, when a metal material, such as a silicon steel plate or a ferrite sintered compact, is used as the magnetic core material, an eddy current occurs to cause a heat loss (so-called eddy-current loss) due to its large conductivity. This means that there is required an avoidance measure with which, for instance, the metal material is molded to multiple thin plates and a multi-layered structure is obtained using the thin plates. In the case of the magnetic core of the invention, however, the magnetic particles are adopted as the magnetic core material and the magnetic particles are arranged with their particle state maintained, so that occurrence of the eddy current in the magnetic core can be canceled. As a result, a heat loss due to the eddy current can be canceled. Thus, by utilizing the magnetic core material using the magnetic particles, a loss in a high-frequency band can be decreased.

Further, generally, a substance obtained by allowing a hydraulic composition to solidify has an extremely high heat resistance property, so that the magnetic core of the invention also has an extremely high heat resistance property. In addition, as is represented by an aggregate added as an extending agent, it is generally possible to add a large volume of another component to the hydraulic composition. As a result, even in the invention, it is possible to increase the mixing ratio of the magnetic particles and to realize the magnetic permeability that the magnetic core is required to possess.

Next, there will be described an action of the electromagnetic characteristic relating to the filling amount of the magnetic particles described above. As an example, there will be discussed a case where there are used the magnetic core 100 shown in FIG. 1 and spherical magnetic particles whose volume average particle diameter is 75 μm (distributed in a range of 40 to 105 μm).

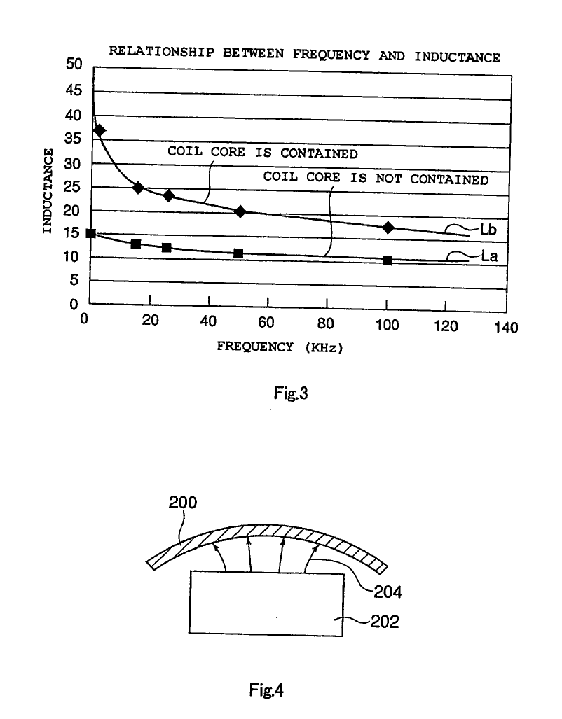

There is obtained relationship between applied signal frequencies and inductance for both a case (corresponding to this embodiment) where a coil core (magnetic core) is contained as an excitation coil and a case where no coil core is contained. FIG. 3 shows experimental results thereof. Note that, in the case where no coil core is contained, the experiment was conducted using, in place of the hold member 102, an excitation coil having a rod-shaped body made of a resin with the same shape.

FIG. 3 shows the characteristics obtained by finding inductance at the time when signals at predetermined frequencies (in the embodiment, six types of frequencies of 1 kHz, 15 kHz, 25 kHz, 50 kHz, 100 kHz, and 200 kHz) were applied to the excitation coil was found and then interpolating the obtained result by at least squares method, etc. In FIG. 3, characteristic graph Lb shows the characteristic of the coil when the coil core (magnetic core) is contained and characteristic graph La shows the characteristic of the coil when no coil core (magnetic core) is contained.

As apparent from FIG. 3, in both the characteristics La and Lb, the inductance tends to decrease with an increase in the applied signal frequency. In the characteristic La when no coil core is contained, the inductance tends to decrease slightly; in the characteristic Lb when the coil core is contained, the inductance fluctuation tendency appears noticeably as compared with that in the characteristic La.

Electric equipment to which an excitation coil or a transformer, (although the transformer will be explained in a later embodiment, it will be additionally explained here), which is an example of the inductance element having the magnetic core described above, can be applied include electric equipment using an electromagnetic coil, electric equipment using a high-frequency circuit or an inverter circuit, and electric equipment such as a motor machine (all of which are electric equipment of the present invention).

For example, the electric equipment each using an electromagnetic coil include a television, a videocassette recorder, an electric shaver, an electric toothbrush, a washing toilet seat, a refrigerator, a facsimile machine, a hand mixer, a ventilating fan, an electric sewing machine, an electric pencil cutter, a CD player, a washing machine, a dryer, a fan, a juice mixer, an air conditioner, an air cleaner, an electrophotographic copier, a vending machine, an electromagnetic valve, etc.

For example, the electric equipment each using a high-frequency circuit or an inverter circuit include an electromagnetic cooker, a microwave oven, PHS, a radio pager, a mobile telephone, a cordless telephone, a desktop personal computer, a notebook personal computer, a word processor, a video game machine, a humidifier, a fluorescent lamp, audio devices such as an amplifier and a tuner, etc.

The motors include a servomotor, a pulse motor, and a stepping motor. For example, the electric equipment each having any of the motors include quartz oscillation type timepiece such as a wrist watch, a table clock, a wall clock, and a stopwatch, a pacemaker, a camera, a videocassette recorder, a video camera, devices for handling rotation-type storage media such as MD, CD, CD-R, CD-RW, FD, PD, and MD, a metering pump, etc.

Further, for example, other electric equipment to which the coil or the transformer, which is an example of the inductance element having the magnetic core described above, can be applied include electric equipment AC adapter, a laser-beam printer, a thermal transfer printer, a dot-impact printer, a CRT display, a liquid crystal display, a plasma display, a GPS navigation device, a magnetic detection sensor, a hearing aid, a charger, etc.

In the embodiment, the mixing ratio and whole shape of the magnetic particles can be changed as desired, so that the hold member 102 serving as a magnetic core can be easily formed to a required size and shape. Therefore, by applying the magnetic particles to a part of a magnetic core constituting an excitation coil or a transformer, the flexibility of circuit design using an inductance element is increased. Also, it is possible to uniformly disperse the magnetic particles in the hydraulic composition at the time of manufacturing, so that it becomes possible to prevent variations in magnetic permeability from occurring in the center portion or at both ends of a magnetic core, which makes it possible to obtain a homogeneous magnetic core and furthermore, a homogeneous excitation coil or transformer.

Thus, in this embodiment, the inductance element can be easily molded to any of various shapes and the magnetic particles are only installed in a part of the magnetic core of an excitation coil or a transformer, so that the inductance of the excitation coil or the transformer can be flexibly designed over a wide range. Further, the magnetic particle itself has adequate electric resistance and thus the self-heating problem caused by so-called induction heating is extremely small even in a high frequency band and therefore the loss is small and the effective magnetic permeability can be enhanced even in the high frequency band.

[Second Embodiment]

Next, a second embodiment concerning a magnetic field shield member of the invention capable of providing a function of suppressing an electromagnetic field leakage easily and at low cost will be discussed.

In the first embodiment, an example has been discussed in which a magnetic core using a material, in which magnetic particles are arranged in a base material under a dispersed state, is used in a part of the magnetic core constituting an inductance element, such as an excitation coil or a transformer, is installed, thereby improving the electromagnetic characteristic of the excitation coil or the transformer. However, such a material, in which magnetic particles are installed in a base material under a dispersed state, can also be used to realize a function of suppressing an electromagnetic field leakage. For example, a member, in which magnetic particles are arranged in a base material under a dispersed state in a like manner (that is, the magnetic field shield member of the invention), can be used as a magnetic field shield member for shielding an electromagnetic field leakage in the surroundings of a magnetic field generation member such as a coil or a transformer having a magnetic core, as well as an air-core coil or transformer having solely a winding and a permanent magnet.

The magnetic field generation member such as an inductance element may involve an electromagnetic field leakage. However, a portion where the inductance element is installed may be small in excessive space or small in shape flexibility. Consequently, by using the magnetic field shield member of the present invention as the magnetic field shield member for shielding an electromagnetic field leakage, a highly flexible magnetic field shield member whose mixing ration of the magnetic particles and shape can be adjusted whenever necessary can be provided.

For example, when a coil or a transformer having a magnetic core and a winding is assembled, a portion for shielding a electromagnetic field leakage may be provided for a holder (hold member) in advance, thereby allowing the holder to double as a holder (magnetic core) and a magnetic field shield member for shielding an electromagnetic field leakage.

FIG. 4 is a schematic sectional view showing a state in which the magnetic field shield member according to this embodiment is placed in the periphery of magnetic field generation member. In FIG. 4, numeral 200 denotes the magnetic field shield member having a function for shielding a leakage magnetic field 204 produced from magnetic field generation member 202. As the magnetic field generation member 202, a permanent magnet, etc., can be named in addition to inductance elements of an excitation coil, a transformer, etc. Further, various electric and electronic equipment containing them are all included. Although it is needless to mention that a magnetic field is required to be formed for the magnetic field generation member 202 to exert its function, a magnetic field also easily leaks to a part not affecting the performance of the function of the magnetic field generation member 202 because of the design thereof. The magnetic field shield member 200 of this embodiment provides the function for shielding such leakage magnetic field 204.

The magnetic field shield member 200 is obtained by preparing a material, in which magnetic particles are arranged in a base material under a dispersed state, and molding the material to a thin-plate curved surface shape. In this embodiment, like in the first embodiment, a solidified hydraulic composition is used as the base material. The face of the magnetic field shield member 200 opposed to the magnetic field generation member 202 is shaped like a curved surface so as to surround the magnetic field generation member 202, thereby making it possible to effectively shield the leakage magnetic field 204 produced from the magnetic field generation member 202. As a matter of course, in the invention, the shape of the magnetic field shield member 200 is not limited to the curved surface, and any other shape, such as a flat-plate shape, a box shape, a ship shape, an angular U shape, a mountain shape, a dome shape, a roof shape, or a combination thereof can be selected appropriately by giving consideration to a leaking manner of a leakage magnetic field, excessive space of a machine, the shape of the magnetic field generation member, and the like.

The types, properties, (shape, magnetic property, and electric property), and mixing ratios of magnetic particles that can be used in the embodiment, and the types, properties, compositions, and the like of the base material and the hydraulic compositions are similar to those previously described in the first embodiment. The thickness of the magnetic field shield member 200 may be adjusted appropriately depending on the strength of a leakage magnetic field.

According to the embodiment, the electromagnetic field leakage can be suppressed or shielded effectively and the performance of an apparatus can be enhanced easily and at low cost without impairing miniaturization as the whole apparatus (machine). Further, the method of suppressing a magnetic flux leakage using the magnetic field shield member of the embodiment is applied to various electric equipment, whereby the leakage magnetic flux density can be decreased easily and at low cost.

Electric equipment, to which an excitation coil or a transformer to be described later (examples of an inductance element having the magnetic field shield member described above) can be applied, are the same as the various electric equipment discussed in the first embodiment (electric equipment of the invention).

<Third Embodiment>

Next, there will be discussed a third embodiment concerning an inductance element that uses the magnetic core of the invention that is capable of realizing high magnetic permeability with ease and at low cost and the magnetic field shield member of the invention that is capable of achieving the function of suppressing an electromagnetic field leakage with ease and at low cost. In this embodiment, a transformer will be described as an example of the inductance element.

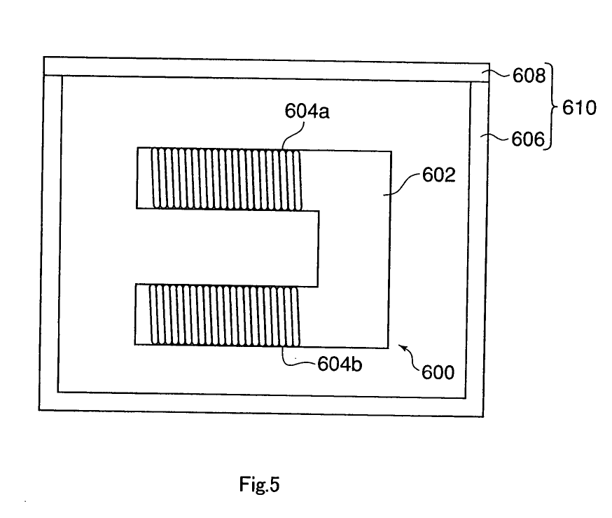

FIG. 5 is a schematic sectional view of a transformer that uses the magnetic core of the invention (transformer of the invention). The transformer of this embodiment is produced by providing a transformer main body 600 in a vessel 610. The transformer main body 600 is produced by winding two coils that are a primary coil 604a and a secondary coil 604b around two opposing sides of a hold member 602 having an angular U shape. Also, the vessel 610 includes a box body 606 having a rectangular parallelepiped shape whose one face is opened and a lid body 608 that is fitted to the box body 606 and closes the opened face. In this embodiment, the magnetic core of the invention is applied to the hold member 602 and the magnetic field shield member of the invention is applied to the vessel 610.

That is, the hold member 602, the box body 606, and the lid body 608 have a structure where magnetic particles are arranged in a base material under a dispersed state. The base material and magnetic particles that are used in this case (and are suited for use) are the same as those discussed in the first and second embodiments and therefore the detailed description thereof is omitted.

The transformer of this embodiment is constructed so that it is possible to extract a transformed voltage from both ends of the secondary coil 604b by applying a predetermined voltage to both ends of the primary coil 604a. In FIG. 5, the terminals of these coils are not illustrated, although these coils are constructed so that it is possible to bring the both ends of the coils into conduction from the outside of the vessel 610.

In this embodiment, the magnetic core of the invention is used as the hold member 602 as described above, so that it is possible to perform molding with ease even if there is used a complicated shape such as an angular U shape, which makes it possible to enhance the flexibility of design of the transformer. Also, occurrence of an eddy current in the magnetic core can be canceled and therefore heat loss due to the eddy current can also be canceled.

The shape of the cross section of the hold member 602 is not specifically limited and may be any other shape such as a circular shape, an oval shape, a rectangular shape, a polygonal shape, an indeterminate shape, or the like, although there is generally used a hold member whose cross-sectional shape is the rectangular shape or the circular shape. The overall shape is set as the angular U shape in this embodiment, although this overall shape is not limited to this and there may be used any other shape such as a U-letter shape, an arc shape, or a rod shape. Further, an example where two coils are wound has been discussed in this embodiment, although three or more coils having the same or different numbers of turns may be wound. In this case, it is possible to select the voltage on the input side and/or the voltage on the output side and the distribution ratio of the voltage.

In the transformer main body 600, when the transformer functions as an impedance element, magnetic fields occur from both end portions of the hold member 602 that is the magnetic core, which leads to a magnetic field leakage. In this embodiment, however, in order to substantially completely shield this magnetic field, the transformer main body 600 is contained in the vessel 610 and a magnetic field shield member is provided so as to surround the transformer main body 600.

In this embodiment, the magnetic field shield member of the invention is used as the vessel 610 as described above, so that it becomes possible to effectively suppress or shield the leakage of an electromagnetic field and to improve the performance of an apparatus with ease and at low cost without inhibiting overall miniaturization of the apparatus. Note that the vessel 610 discussed in this embodiment as an example has a simple shape for ease of explanation, although even when a complicated shape is desired in order to meet a demand for overall miniaturization of the apparatus, it becomes possible to form the vessel 610 to a desired shape with ease because the construction of this embodiment adopting the magnetic field shield member of the invention has high flexibility in shape.

[Fourth Embodiment]

Next, a case where an inductance element using the magnetic core of the invention is applied to an electrophotographic apparatus as electric equipment will be discussed. In this embodiment, a case where the magnetic core of the invention is applied to a fusing device in an electrophotographic apparatus will be discussed. Note that this embodiment has almost the same construction as in the above-described embodiment and therefore portions that are the same as those previously described are denoted by the same reference numerals and will not be discussed again in detail.

Generally, an electrophotographic apparatus includes an image formation unit for forming an unfixed toner image on the surface of a record medium using electrophotography and fuser unit for fixing the toner image on the surface of the record medium on which the unfixed toner image has been formed.

Conventionally, in a recorder of heating and fixing type in a copier, a printer, or the like, a fusing device has been used as a fuser unit for heating and fixing a fixing target material typified by toner on a record material. As the heating method of the fusing device, a lamp method of performing heating with a lamp, such as a halogen lamp, and an electromagnetic induction heating method of performing heating by interlinking an alternating magnetic field with a magnetic conductor and generating an eddy current are available.

The fusing device adopting the electromagnetic induction heating method can directly heat a heating target material, such as a thermal roll, by using Joule heat produced by an eddy current and thus has the advantage that highly efficient heating can be carried out as compared with the lamp method.

In the embodiment, there will be discussed an example where a fusing device adopting the electromagnetic induction heating method is used as the fuser unit. Also, in the example discussed in the embodiment, a fusing device of so-called roll-roll nip type using roll-like members for both a fixing rotation body and a pressurizing rotation body is applied.

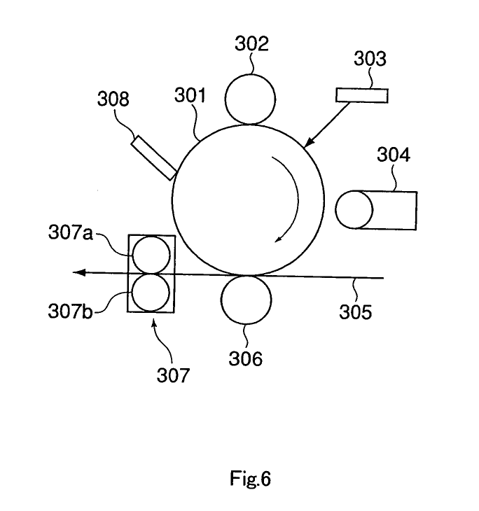

FIG. 6 is a schematic drawing to show an electrophotographic apparatus of the embodiment. The electrophotographic apparatus in this drawing includes a photoconductive drum 301 having a cylindrical shape on whose surface there is formed a latent image through irradiation of image light after uniform charging. Around the photoconductive drum 301, there are provided a charger 302 for uniformly charging the surface of the photoconductive drum 301, a light exposure device 303 for forming a latent image by irradiating the image light onto the photoconductive drum 301, a developing device 304 for forming a toner image by selectively transferring toner onto the latent image on the surface of the photoconductive drum 301, a transfer device 306 for forming an unfixed image by transferring the toner image formed on the surface of the photoconductive drum 301 onto a record material 305, a fusing device 307 for heating and fixing the unfixed image, and a cleaning device 308 for recovering toner residing on the surface of the photoconductive drum 301. The fusing device 307 includes a heating roll 307a obtained by forming a mold release layer made of a mold release resin on a core metal made of a magnetic metal (iron, for example) and a pressurizing roll 307b provided so as to press-contact with the heating roll 307a and pressurizes and fixes the unfixed toner.

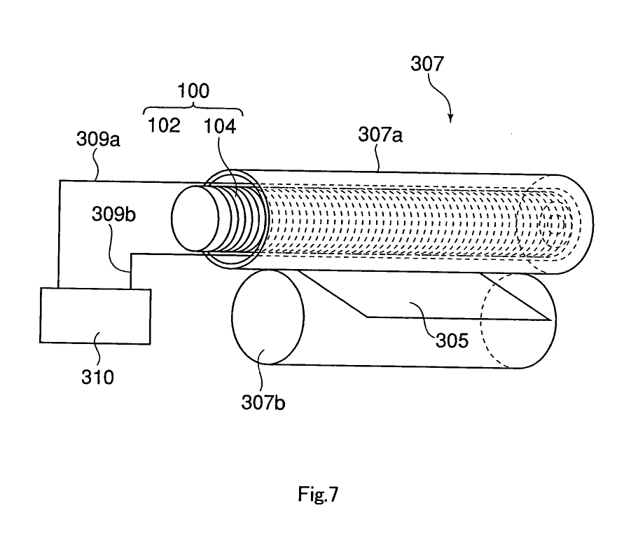

FIG. 7 is a schematic drawing showing the fusing device 307. The fusing device 307 has a construction where the heating roll (fixing rotation body) 307a is made of a magnetic metal (for example, iron) and an excitation coil 100 is placed in the heating roll 307a as an induction heating coil (magnetic field generation member) for supplying heat energy to the heating roll 307a. This excitation coil 100 is the same as the excitation coil discussed in the first embodiment, so that the same reference numerals as in the first embodiment are used and the detail description thereof will be omitted in this embodiment.

In the embodiment, a conductive layer that generates heat by causing an eddy current to occur through electromagnetic induction is the heating roll 307a itself made of a magnetic metal. In the invention, it is indispensable to form a conductive layer in the proximity of the peripheral surface of the fixing rotation body. Another conductive layer may be formed on the peripheral surface of a base material of the fixing rotation body. Also, the base material itself may form a conductive layer as in the embodiment. As a matter of course, in either case, any other layer such as an elastic layer or a mold release layer may be further formed on the surface of the conductive layer. The conductive layer that is another formed conductive layer and other layers are the same as those described in embodiments to be discussed later.

The base material does not contribute to heating and therefore is not specifically limited. Consequently, any of various plastic materials, metallic materials, ceramic materials, glass materials, and the like can be used without any problem.

Here, the expression “the proximity of the peripheral surface” defined in the invention is used to mean the proximity to such an extent that when the conductive layer generates heat through electromagnetic induction, even when another layer is formed on the peripheral surface, the heat propagates to the peripheral surface and the temperature of the peripheral surface can become a temperature that is sufficient for fixing (or transfer fixing). Therefore, the depth from the peripheral surface defining “the proximity of the peripheral surface” varies largely depending on various conditions, and no specific numeric value can be shown. When the base material itself constitutes a conductive layer and another layer is formed on the peripheral surface, the conductive layer is exposed to the inside of the layer. Also in this case, whether the condition “the proximity of the peripheral surface” is satisfied is judged by focusing attention only on a state from the peripheral surface.

The pressurizing roll 307b is pressed against the heating roll 307a and record paper (medium to be recorded) 305 on which an unfixed toner image is formed is inserted into a nip portion formed between the pressurizing roll 307b and the heating roll 307a so that the side, on which the unfixed toner image is formed, comes into contact with the heating roll 307a, whereby the toner image is fixed. An incoming end 309a and an outgoing end 309b of the coil 104areconnected to a high-frequency power supply 310. With this construction, a high-frequency current is supplied to the excitation coil 100. That is, the high-frequency power supply 310 is provided in order to supply a high-frequency current to the excitation coil 100.

The gap between the heating roll 307a and the excitation coil 100 is made small (1.0 mm, in the embodiment) and a high-frequency current is allowed to pass through the excitation coil 100, thereby directly heating the heating roll 307a.

The operation of the fusing device 307 according to the embodiment is as follows: When a switch (not shown) is operated, the high-frequency power supply 310 supplies a high-frequency current to the excitation coil 100, which then generates a high-frequency magnetic field in accordance with the supplied high-frequency current. Accordingly, the heating roll 307a made of a magnetic metal is placed in an alternating magnetic flux repeatedly produced and extinguished and thus an eddy current occurs so as to generate a magnetic field for preventing magnetic field change in the heating roll 307a. The eddy current and electric resistance of the heating roll 307a cause Joule heat to occur, thereby heating the heating roll 307a.

As described above, in the fusing device 307 of the embodiment, the gap between the heating roll 307a and the excitation coil 100 is made small, so that the electromagnetic induction heating efficiency to the excitation coil 100 can be improved.

Also, in the embodiment, a material in which magnetic particles are arranged in a base material under a dispersed state is used as a magnetic material contributing to heat generation in the fusing device, so that a magnetic core and furthermore a magnetic field generation member can be easily formed or manufactured to any of various shapes. Therefore, the flexibility of design of the fusing device can be expanded. Further, in the fusing device of the this embodiment, the magnetic core contributes to heat generation and therefore the magnetic core itself is exposed to a high temperature, although a solidified hydraulic composition is used as the base material constituting the magnetic core. As a result, it is possible to impart a sufficient heat resistance property against the generated heat to the magnetic core.

In the embodiment, magnetic particles are used as a magnetic material contributing to heat generated in the fusing device and the magnetic material is maintained in the particle state, so that occurrence of an eddy current in the magnetic core can be canceled, thereby the heat loss of the eddy current can be canceled. That is, an electrophotographic apparatus of high energy efficiency can be provided.

[Fifth Embodiment]

Next, a fifth embodiment concerning an electrophotographic apparatus in which a magnetic field shield member of the invention capable of providing a function for suppressing an electromagnetic field leakage from electric equipment is applied to electromagnetic shielding of a fusing device will be discussed. The embodiment has an almost similar configuration to that of the above-described embodiments and therefore parts identical with those previously described are denoted by the same reference numerals and will not be discussed again in detail.

As descried above, generally an electrophotographic apparatus has an image formation unit for forming an unfixed toner image on the surface of a record medium using electrophotography and a fuser unit for fixing toner image on the surface of the record medium on which the unfixed toner image is formed. Also in the fourth embodiment, an example of using a fusing device adopting the electromagnetic induction heating method as a fuser unit is shown although the configuration differs from that of the fourth embodiment.

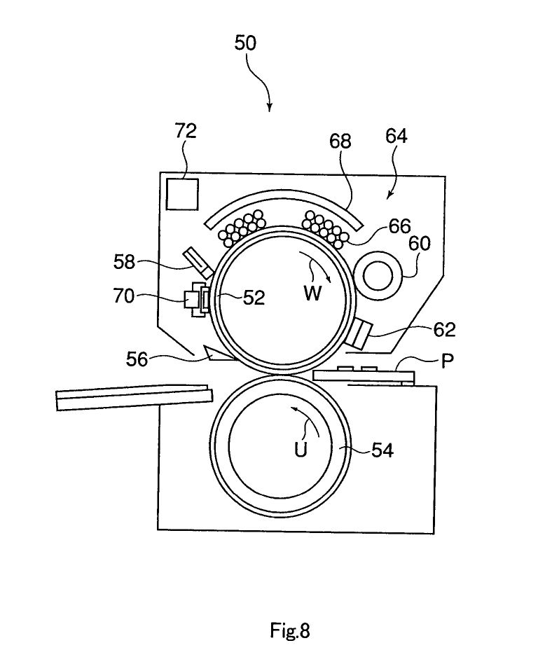

In the fourth embodiment, as the fusing device, for example, a fusing device of so-called roll-roll nip type using roll-like members for both a fixing rotation body and a pressurizing rotation body is applied. Other components than the fusing device are not limited in the invention and therefore in the embodiment, only a fusing device 50 adopting the electromagnetic induction heating method will be discussed with reference to FIG. 8.

FIG. 8 is a schematic sectional view showing the general configuration of the fusing device 50 according to the embodiment. The fusing device 50 has a heating roll (fixing rotation body) 52 (40 mm F) and a pressurizing roll (pressurizing rotation body) 54 (40 mm F) . The pressurizing roll 54 is pressed against the heating roll 52 by a pressurizing mechanism (not shown) to form a nip part so as to have a constant nip width. The heating roll 52 is driven in a predetermined direction (an arrow W direction in FIG. 8) by a drive motor (not shown) to drive the pressurizing roll 54 to rotate in following manner in a predetermined direction (an arrow U direction in FIG. 8). The heating roll 52 is made of iron and has a thickness of 0.5 mm. The heating roll 52 is coated on the surface thereof with a mold release layer of fluorine resin, etc. In the embodiment, iron is used as the roll material, but stainless steel, aluminum, a composite material of stainless steel and aluminum, or the like may be used.

The pressurizing roll 54 is formed by coating a cored bar coated on the periphery thereof with silicone rubber, fluorine rubber, or the like. Paper (record medium) P on which an unfixed toner image is formed passes through (is inserted into) the fixing point of the press contact part (nip part) between the heating roll 52 and the pressurizing roll 54, whereby the toner on the paper P is fused to be fixed. At this time, of course, the paper P is inserted into the nip part so that the side on which the unfixed toner image is formed comes in contact with the heating roll 52.

The heating roll 52 is surrounded by a peeling claw 56 for peeling the paper P from the heating roll 52, a cleaning member 58 for removing foreign particle such as paper chips and toner offset on the surface of the heating roll 52, an induction heater 64 as magnetic field generation member, a mold release agent applicator 60 for applying a mold release agent for offset prevention, and a thermister 62 for detecting the temperature of the heating roll 52 in order in the downstream in the rotation direction from the contact position (nip part) between the heating roll 52 and the pressurizing roll 54.

The fusing device uses the electromagnetic induction heating method of the induction heater 64 as the heating principle. The induction heater 64 has a coil 66 and is placed on the outer peripheral surface of the heating roll 52. The coil 66 uses copper wire rods each having a wire diameter of 3 mm F and is configured as Litz wire having a bundle of wire rods insulated from each other. The coil 66 is configured as Litz wire, whereby the wire diameter can be made smaller than osmosis depth to make it possible to allow an alternating current to flow effectively. In the embodiment, 16 wire rods each having a wire diameter of 0.5 mm are bundled. The Litz wire is coated with heat resisting polyamide imide. The coil 66 is placed in the proximity of the heating roll 52 in a state in which the coil 66 is opposed to the surface of the heating roll 52, and functions as magnetic field generation member.

Further, on the opposite side of the coil 66 to the heating roll 52, a magnetic field shield member 68 is placed in the proximity of the coil 66. The detailed operation of the magnetic field shield member 68 will be discussed later.

Also in the embodiment, the heating roll 52 is formed of magnetic metal and the heating roll 52 itself becomes a conductive layer for causing an eddy current to occur by electromagnetic induction to generate heat. Of course, in the invention, similarly to the fourth embodiment, another conductive layer may be formed and any other layer such as an elastic layer or a mold release layer may be further formed on the surface of the conductive layer.

The coil 66 is connected to an excitation circuit (inverter circuit) 72 and a magnetic flux and an eddy current are caused to occur in the heating roll 52 formed of magnetic metal so as to hider change in a magnetic field by magnetic flux generated by a high-frequency current applied from the excitation circuit 72 to the coil 66. Joule heat is generated by the eddy current and resistance of the heating roll 52 to heat the heating roll 52. In the embodiment, a high-frequency current of frequency 20 kHz and output 900 W is applied to the coil 66. The surface temperature of the heating roll 52 is set to 180° C. and is controlled. The surface temperature is sensed by the thermister 62 and the heating roll 52 is heated by feedback control. At this time, in order to make a uniform temperature distribution of the whole roll, the heating roll 52 and the pressurizing roll 54 rotate. As the rolls are rotated, a constant heat quantity is given to the full face of each roll.

When the surface temperature of the heating roll 52 reaches 180° C., the image formation operation (so-called copy operation) is started and paper P on which an unfixed toner image is formed passes through the fixing point of the press contact part (nip part) between the heating roll 52 and the pressurizing roll 54, whereby the toner on the paper P is fused to be fixed. Electric current to the excitation circuit 72 is supplied through a thermostat 70, which is a temperature fuse pressed against the surface of the heating roll 52. The allowable surface temperature of the heating roll 52 is preset in the thermostat 70 and when the surface temperature reaches an abnormal temperature exceeding the allowable temperature, the thermostat 70 shuts off the electric current supplied to the excitation circuit 72.

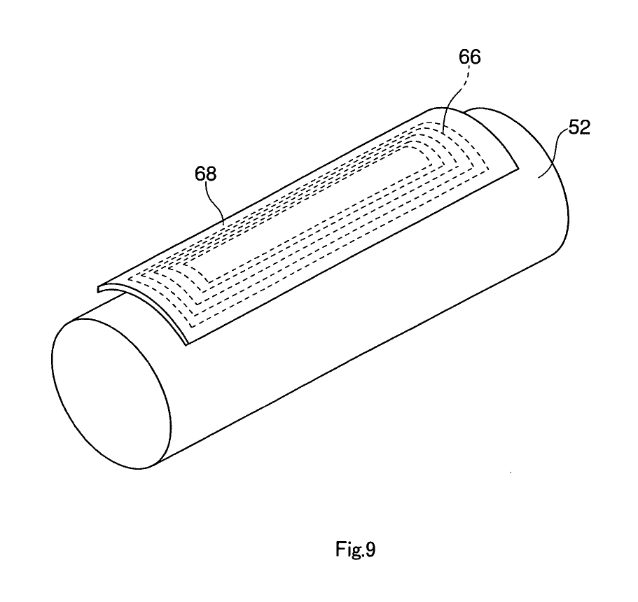

FIG. 9 is a perspective view schematically showing the heating roll 52 and the induction heater 64 in the embodiment. As shown in FIG. 9, the coil 66 (indicated by the dotted line in FIG. 9) is placed under a state in which the coil 66 is opposed to the outer peripheral surface of the heating roll 52. The distance (gap) between the heating roll 52 and the coil 66 is set at 1 mm. The coil 66 is configured as an air-core coil and on the opposite side of the coil 66 with reference to the heating roll 52, the magnetic field shield member 68 is provided in the proximity of the coil 66. The magnetic field shield member 68 is provided in the proximity of the coil 66 so as to cover the coil 66 and is realized by a member, in which magnetic particles are arranged in a solidified hydraulic composition under a dispersed state, that is, by the magnetic field shield member of the invention. The specific composition of the magnetic field shield member used in the embodiment is the same as that of the magnetic core 100 in the first embodiment.

In the embodiment, the distance (gap) between the coil 66 and the magnetic field shield member 68 is set to 5 mm. The magnetic field shield member 68 is placed so that if the air-core coil (namely, the coil 66) is placed in the proximity of the outer periphery of the heating roll 52, a magnetic field leaked to the outside (at least a part of a leakage magnetic field not affecting the heating roll 52 functioning as a conductive layer) is shielded. Thus, a problem of noise, etc., produced by electromagnetic field leakage can be eliminated. The magnetic field shield member 68 is placed, so that if the coil 66 itself generates a magnetic field in any area other than the heating roll 52 side, no problem arises. Thus, a coil that can be easily molded can be used as the coil 66.

On the other hand, if the magnetic field shield member 68 does not exist and the induction heater 64 is placed in the proximity of the outer periphery of the heating roll 52, a core material shaped so as to prevent a magnetic field from leaking to the outside of the fusing device 50 must be used for the coil 66, which limits the shape of the coil 66 or makes the core material a complicated shape. In the embodiment, the magnetic field shield member 68 may be placed separately in relation to the induction heater 64 and does not depend on the induction heater 64. Since the coil 66 need not be made a complicated shape, an increase in cost is not incurred. In the embodiment, the case where the magnetic field shield member 68 has the curved surface shape corresponding to the circumferential surface has been described, but the shape is not limited to the curved surface shape and even if the shape is plain or any other shape, the shield effect can be produced.

The magnetic field shield member 68 is thus placed, so that if the coil 66 is placed in the proximity of the outer periphery of the heating roll 52, a magnetic field is not leaked to the outside on the opposite side of the coil 66 to the heating roll 52. Thus, the induction heater 64 need not be entered in the inside of the heating roll 52, thereby preventing the radiant heat in the heating roll 52 from causing the coil 66 to be heated and degraded or the magnetic core to be heated and degraded to lower the heat efficiency.

In the embodiment, the case where the distance between the magnetic field shield member 68 and the coil 66 is set to 5 mm has been described, but needless to say, even if the magnetic field shield member 68 is brought into contact with the coil 66, the effect of the invention can be obtained.

A member, in which magnetic particles are arranged in a base material under a dispersed state, is used as the magnetic field shield member in the embodiment as described above, so that the magnetic field shield member can be easily molded to any of various shapes and can be easily manufactured. Therefore, the performance of the fusing device and furthermore the electromagnetic apparatus can be enhanced with ease and at low cost without inhibiting miniaturization of the parts. Also, in the fusing device of the present embodiment, a coil and a heating roll existing in the proximity of the magnetic field shield member contribute to heat generation and therefore the magnetic field shield member is exposed to a high temperature, although a solidified hydraulic composition is used as the base material constituting the magnetic field shield member and therefore it is possible to impart a sufficient heat resistant property against the generated heat to the magnetic field shield member.

It should be noted here that suppression of a magnetic flux leakage is also demanded in various electric equipment and when the magnetic field shield member of the invention is applied to them, a leakage magnetic flux density can be decreased with ease and at low cost.

[Sixth Embodiment]

Next, a sixth embodiment concerning an electrophotographic apparatus in which an inductance element using a magnetic core of the invention is used and a magnetic field shield member of the invention capable of providing a function for suppressing an electromagnetic field leakage is applied to electromagnetic shielding of a fusing device will be discussed.

As described above, generally an electrophotographic apparatus has an image formation unit for forming an unfixed toner image on the surface of a record medium using electrophotography and a fuser unit for fixing toner image on the surface of the record medium on which the unfixed toner image is formed. Also in the sixth embodiment, an example of using a fusing device adopting the electromagnetic induction heating method as a fuser unit is shown although the configuration differs from that of the fourth or fifth embodiment.

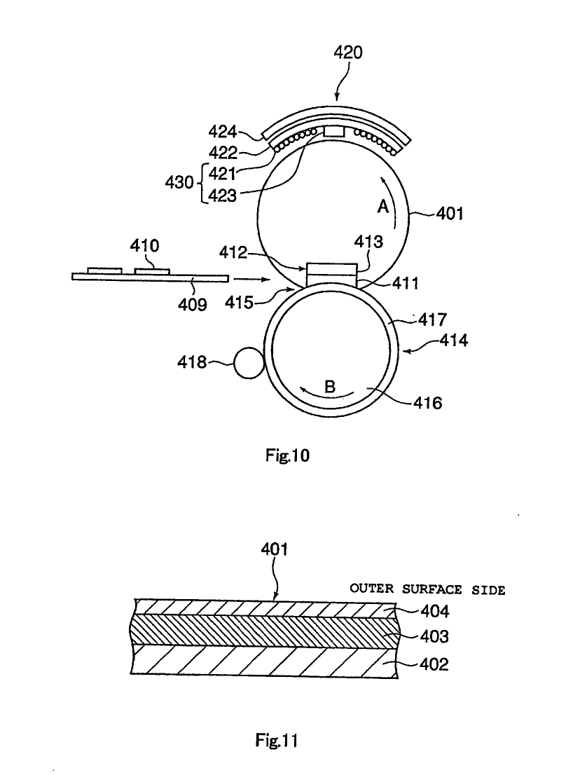

In the sixth embodiment, as the fusing device, for example, a fusing device of so-called belt-roll nip type using an endless belt member for a fixing rotation body and a roll-like member for a pressurizing rotation body is applied. Other components than the fusing device are not limited in the invention and therefore in the embodiment, only a fusing device adopting the electromagnetic induction heating method will be discussed with reference to FIG. 10.

For the purposes of shortening the warm-up time and providing peeling performance of a record medium, the fusing device in the embodiment uses a (flexible) endless belt member having a small heat capacity as a fixing rotation body, and the number of members that removes heat is decreased as much as possible (the members are not eliminated as much as possible) in the endless belt member. That is, in the endless belt member (heating belt), only a pad member (press member) having an elastic layer forming a fixing nip part is basically placed opposed to a pressurizing member. The endless belt member to be heated is provided with a conductive layer and is induction heated by a magnetic field generated by a magnetic field generation member so that the endless belt member can be heated directly.

FIG. 10 is a schematic drawing showing the configuration of the fusing device according to the embodiment.

In FIG. 10, numeral 401 denotes a heating belt as a fixing rotation body. The heating belt 401 has an endless belt having a conductive layer. Thus, in the invention, the “fixing rotation body” contains the endless belt member in addition to the roll-like member described above. The “pressurizing rotation body” also contains both the roll-like and endless belt members.

The heating belt 401 basically has at least three layers of a base material layer 402 made of a sheet member having a high heat resistance property, a conductive layer 403 deposited on the base material layer 402, and a surface mold release layer 404 as a top layer, as shown in FIG. 11. In the embodiment, an endless belt having a diameter of 30 mm F and having the three layers of the sheet-like base material layer 402, the conductive layer 403, and the surface mold release layer 404 is used as a heating belt 401.

Preferably, the base material layer 402 of the heating belt 401 is a sheet having a high heat resistance property, for example, 10 to 200 μm thick, and more preferably 50 to 200 μm thick (for example, 75 μm. For example, a layer made of a synthetic resin having a high heat resistance property such as polyester, polyethylene terephthalate, polyether sulfone, polyether ketone, polysulfone, polyimide, polyimide amide, or polyamide can be named.

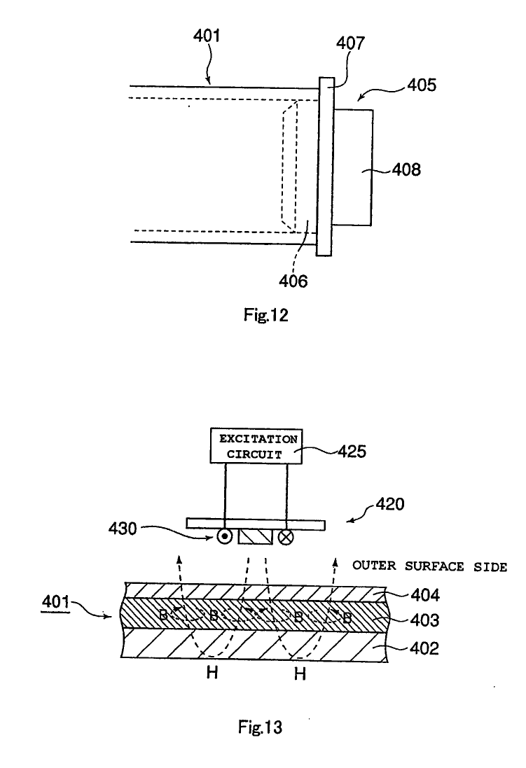

In the embodiment, both end parts of the heating belt 401 formed of an endless belt are abutted against an edge guide 405 to regulate meandering of the heating belt 401 for use, as shown in FIG. 12. FIG. 12 is an enlarged explanatory diagram showing a state in which one end part opening of the heating belt 401 shaped like a pipe is abutted against the edge guide 405 to regulate meandering of the heating belt 401. The other end part opening of the heating belt 401 is also abutted against the similar edge guide (hereinafter, may be referred to as “an edge guide (not shown)”).

The edge guide 405 has a cylindrical part 406 having an outer diameter a little smaller than the inner diameter of the heating belt 401, a flange part 407 provided at an end part of the cylindrical part 406, and a hold part 408 formed in a cylindrical shape or a columnar shape and projected to the outside of the flange part 407. The edge guide 405 and the edge guide (not shown) are disposed in a state in which both end parts of the heating belt 401 can slide and are fixed to the fusing device so that a distance between the inner wall face of the flange part 407 and the inner wall face of a flange part at the edge guide (not shown) against which the opposite end part opening of the heating belt 401 is abutted becomes a little longer than the length along the axial direction of the heating belt 401. Thus, the base material layer 402 of the heating belt 401 needs to have rigidity to such an extent that a circular form 30 mm F in diameter is maintained in any other portion than the nip part during rotation of the heating belt 401 (in the arrow A direction in FIG. 12), and that if the end part of the heating belt 401 is abutted against the edge guide 405, the heating belt 401 has such rigidity to prevent buckling, etc.; for example, a sheet made of polyimide 50 μm thick is used.

The conductive layer 403 is a layer for induction heating by the electromagnetic induction action of a magnetic field generated by the magnetic field generation member described later; a metal layer of iron, cobalt, nickel, copper, chromium, etc., is formed with a thickness of about 1 to 50 μm for use as the conductive layer 403. In the embodiment, however, the heating belt 401 needs to follow the shape of the nip part formed by the pad described later and the pressurizing roll in the nip part and thus needs to be a flexible belt, and further the conductive layer 403 is preferably made thin as much as possible.

In the embodiment, as the conductive layer 403, an extremely thin layer of copper having high conductivity about 5 μm thick is evaporated onto the base material layer 402 made of polyimide so that the heating efficiency thereof becomes high.

Since the surface mold release layer 404 is a layer that directly comes in contact with an unfixed toner image 410 transferred onto paper 409 of a record medium, it is desirable that a material having a good mold release property should be used. As the material forming the surface mold release layer 404, for example, tetrafluoroethylene perfluoro alkyl vinyl ether copolymer (PFA), polytetrafluoroethylene (PTFE), silicone resin, a composite layer of them, or the like can be named. The surface mold release layer 404 is made of material appropriately selected from these materials and is provided with a thickness of 1 to 50 μm as the top layer of the heating belt 401. If the surface mold release layer 404 is too thin, durability is poor with respect to abrasive resistance and the life of the heating belt 401 is shortened; in contrast, if the surface mold release layer 404 is too thick, the heat capacity as the whole heating belt 401 is increased, prolonging the warm-up time. Therefore, both cases are not desirable.

In the embodiment, tetrafluoroethylene perfluoro alkyl vinyl ether copolymer (PFA) 10 μm thick is used as the surface mold release layer 404 of the heating belt 401 considering the balance between the abrasive resistance and the heat capacity as the whole heating belt 401.

For example, a pad member 412 as a press member having an elastic layer 411 of silicone rubber, etc., is placed in the heating belt 401 described above. In the embodiment, there is used one as the pad member 412, in which the elastic layer 411 made of silicone rubber with rubber hardness 35° C. (JIS-K 6253 Type A) is deposited on a support member 413 having rigidity, made of a metal of stainless steel, iron, etc., a synthetic resin having a high heat resistance property, or the like. For example, the elastic layer 411 made of silicone rubber is made uniformly thick for use. The support member 413 of the pad member 412 is placed in a state in which the support member 413 is fixed to a frame of the fusing device (not shown), but may be pressed against the surface of a pressurizing roll 414 (described later) by an urging member such as a spring (not shown) so that the elastic layer 411 is brought into press contact with the surface of the pressurizing roll 414 by a predetermined press pressure.

The fusing device has the pressurizing roll 414 as a pressurizing rotation body placed in the portion opposed to the pad member 412 via the heating roll 401. A nip part 415 is formed with the heating belt 401 sandwiched between the pressurizing roll 414 and the pad member 412, and the paper 409 onto which the unfixed toner image 410 is transferred is passed through the nip part 415, whereby the unfixed toner image 410 is fixed onto the paper 409 by heat and pressure to form a fixed image.

In the embodiment, a pressurizing roll provided by coating the surface of a solid iron roll 416 having a diameter of 26 mm? with tetrafluoroethylene perfluoro alkyl vinyl ether copolymer (PFA) 30 μm thick as a surface mold release layer 417 is used as the pressurizing roll 414.

The pressurizing roll 414 is provided with a metal roll 418 made of a metal such as aluminum or stainless steel having good thermal conductivity so that the metal roll 418 can come into contact with and separate from the pressurizing roll 414, as shown in FIG. 10. When the temperatures of the heating belt 401 and the pressurizing roll 414 are low in the early morning when energizing the fusing device is being energized, etc., the metal roll 418 stops at a position away from the pressurizing roll 414. In the fusing device, when a temperature difference along the axial direction occurs between the heating belt 401 and the pressurizing roll 414 as the fusing device is used, for example, when fixing processing is consecutively performed for small-sized paper, the metal roll 418 is brought into contact with the pressurizing roll 414. When the metal roll 418 is in contact with the pressurizing roll 414, it is driven with rotation of the pressurizing roll 414. In the embodiment, a solid roll made of aluminum having a diameter of 10 mm F is used as the metal roll 418.

In the embodiment, the pressurizing roll 414 is rotated by a drive member (not shown) in a state in which it is pressed against the pad member 412 via the heating belt 401 by a pressurizing member (not shown).

The heating belt 401, which is a fixing rotation body, is circulated with rotation of the pressurizing roll 414. Then, in the embodiment, to provide good slidability, a sheet material having strong abrasion resistance and good slidability, for example, a glass fiber sheet impregnated with fluorine resin (CHUKO KASEI KOGYO KK: FCF400-4, etc.,) is made to intervene between the heating belt 401 and the pad member 412 and further a mold release agent of silicone oil, etc., is applied to the inner face of the heating belt 401 as a lubricant for enhancing slidability. Thus, at the actual heating time, the drive torque at the idling time of the pressurizing roll 414 can be decreased from about 6 kg . cm to about 3 kg . cm. Therefore, the heating belt 401 can be driven with rotation of the pressurizing roll 414 without slipping and can be circulated at the speed equal to the rotation speed of the pressurizing roll 414 in the arrow B direction.

Motion of the heating belt 401 at both end parts thereof in an axial direction is regulated by the edge guide 405, as shown in FIG. 12 to prevent meandering, etc., of the heating belt 401.

In the embodiment, the thin heating belt having the conductive layer is induction heated by a magnetic field generated by the magnetic field generation member.

A magnetic field generation member 420 is a member formed long sideways in a direction orthogonal to the rotation direction of the heating belt 401, which is a length direction, and formed to have a curved shape, and is installed outside the heating belt 401 with a gap of about 0.5 mm to 2 mm between the magnetic field generation member 420 and the heating belt 401. In the embodiment, the magnetic field generation member 420 includes a coil 421, an excitation coil 430 formed of a magnetic core 423 placed at the center of the coil 421, and a coil support member 422 for supporting the excitation coil 430. A magnetic field shield member 424 is placed on the opposite side of the excitation coil 430 to the heating belt 401.

As the excitation coil 421, for example, a predetermined number of Litz wires each having a bundle of 16 copper wire rods insulated from each other and each having a diameter of 0.5 mm F are lineary placed in parallel by a predetermined number.

As shown in FIG. 13, an alternating current of a predetermined frequency is applied to the coil 421 by an excitation circuit 425, whereby a fluctuating magnetic field H occurs in the surroundings of the excitation coil 430 and when the fluctuating magnetic field H crosses the conductive layer 403 of the heating belt 401, an eddy current B occurs in the conductive layer 403 of the heating belt 401 so as to generate a magnetic field hindering change in the magnetic field H by the electromagnetic induction action. The frequency of the alternating current applied to the coil 421 is set in a range of 10 to 50 kHz, for example. In the embodiment, the frequency of the alternating current is set to 30 kHz. Then, the eddy current B flows through the conductive layer 403 of the heating belt 401, whereby Joule heat is generated by electric power proportional to the resistance of the conductive layer 403 (W=IR²) to heat the heating belt 401, which is the fixing rotation body.

It is desirable that a heat resisting nonmagnetic material should be used as a coil support member 422; for example, heat resisting glass or a heat resisting resin of polycarbonate, etc., is used.

The magnetic core 423 that is the magnetic core of the invention is provided at the center of the coil 421. The magnetic core 423 is made of a material in which magnetic particles are arranged in a solidified hydraulic composition under a dispersed state. Also, the magnetic core 423 is the same as that discussed in the first embodiment except for the shape. The magnetic core 423 of this embodiment has a rectangular parallelepiped shape and has a structure where magnetic particles are dispersed and arranged uniformly and the particle state of the magnetic particles is maintained. Also, the magnetic core 423 can be changed in shape as desired and can be formed to a required size and shape with ease. As a result, according to this embodiment, there is increased the flexibility of design of the magnetic field generation member 420. Note that the details of the magnetic particles are also the same as those discussed in the first embodiment.

By using the magnetic particles, since the magnetic particle itself has adequate electric resistance, the self-heating problem caused by so-called induction heating is extremely small even in a high frequency band and therefore the loss is small and the effective magnetic permeability can be enhanced even in the high frequency band.

In the embodiment, the magnetic core 423 is provided, whereby a magnetic flux occurring in the excitation coil 421 can be gathered efficiently and the heating efficiency can be raised. Thus, it is made possible to lower the frequency of a high-frequency power supply for applying an alternating current to the excitation coil 421 and decrease the number of turns of the excitation coil 421, and the power supply and the excitation coil 430 can be miniaturized and the cost can be reduced.

On the other hand, in the embodiment, the magnetic field shield member 424 uses the magnetic field shield member of the invention. The magnetic field shield member 424 is provided to gather magnetic fluxes occurring in the excitation coil 430 to form a magnetic passage; the magnetic field shield member 424 makes it possible to conduct heating with efficiency and prevents a magnetic flux from leaking to the outside of the fusing device and heating peripheral members unwillingly.

The magnetic field shield member 424 is filled with magnetic particles in a cover-like vessel placed in the proximity of the excitation coil 430 so as to cover the excitation coil 430. The specific configuration of the magnetic field shield member 424 is similar to that of the magnetic field shield member in the fifth embodiment.

Since the magnetic particles are dispersed in the solidified composition of hydraulic property to be used as the magnetic field shield member in the embodiment, the magnetic field shield member can be easily molded to any of various shapes and can be easily manufactured. Therefore, the performance of the fusing device, and furthermore, the performance of the electrophotographic apparatus can be enhanced easily and at low cost without inhibiting miniaturization of the parts.

It should be noted here that the coil support member 422 and the magnetic core 423 may be integrated with each other and may be formed using a material in which magnetic particles are arranged in a base material under a dispersed state. In this case, the coil support member 422 possesses the function of a magnetic field shield member, so that the magnetic field shield member 324 becomes unnecessary. That is, the magnetic core and the magnetic field shield member are integrated with each other and also have the function of the coil support member for holding the excitation coil. The material used in the invention (material in which magnetic particles are arranged in a base material under a dispersed state) can be produced to a desired shape with ease and also has a shape maintaining property. As a result, even a part having a complicated shape like this (part obtained by integrating the magnetic core with the magnetic field shield member) can be produced with ease and at low cost.

In the described configuration, the fusing device in the embodiment makes it possible to set the warm-up time to almost zero, to provide a good fixing property, and to reliably prevent a peel failure from occurring.

That is, in the fusing device in the embodiment, as shown in FIG. 10, the pressurizing roll 414 is rotated in the arrow B direction by a drive source (not shown) at process speed of 100 mm/s. The heating belt 401 comes into press-contact with the pressurizing roll 414 and is circulated at the speed 100 mm/s equal to the moving speed of the pressurizing roll 414.

In the fusing device, as shown in FIG. 10, the paper 409 on which the unfixed toner image 410 is formed by a transfer device (not shown) is passed through the nip part 415 formed between the heating belt 401 and the pressurizing roll 414 so that the side of the paper 409 on which the unfixed toner image is formed comes in contact with the heating belt 401, and while the paper 409 is passed through the nip part 415, it is heated and pressurized by the heating belt 401 and the pressurizing roll 414, whereby the unfixed toner image 410 is fixed onto the paper 409 as a toner image.

At that time, in the fusing device, the temperature of the heating belt 401 at the entrance of the nip part 415 is controlled at about 180° C. to 200° C. during the fixing operation by the frequency of a high-frequency current allowed to flow into the excitation coil 421.

In the fusing device in the embodiment, the pressurizing roll 414 starts to rotate and a high-frequency current is supplied to the excitation coil 421 at the same time as an image formation signal is input. For example, when electric power of 700 W as effective electric power is input to the excitation coil 421, the heating belt 401 reaches a temperature at which fixing is possible in about two seconds from the room temperature by the induction heating action. That is, warm-up is completed within a time required for the paper 409 to move from a paper feed tray to the fusing device. Therefore, the fusing device can perform fixing processing without making the user wait.

If paper 409 (thin paper having about 60 g/m²) onto which a large amount of toner such as a color solid image is transferred enters the nip part 415 of the fusing device, usually the attraction force becomes strong between the toner and the surface mold release layer 404 of the heating belt 401 and it becomes hard to peel the paper 409 from the surface of the heating belt 401. In the embodiment, however, the shape of the heating belt 401 is convex outside the nip part 415 and is concave inside the nip part 415. That is, the paper 409 is wound around the pressurizing roll 414 side inside the nip part 415 and the shape of the heating belt 401 changes rapidly from concave to convex at the exit of the nip part 415. Thus, the paper 409 cannot follow the rapid change in the shape of the heating belt 401 because of the firmness (rigidity) of the paper 409 itself, and is naturally peeled off from the heating belt 401. Therefore, in the fusing device in the embodiment, a peel failure problem of the paper 409 can be reliably prevented from occurring.

If small-sized paper 409 is consecutively fixed, the temperatures of the heat belt 401, the pad member 412, the pressurizing roll 414, and the like in the area through which paper does not pass rise. However, the metal roll 418 placed on the side of the pressurizing roll 414 is brought into contact with the surface of the pressurizing roll 414, whereby the metal roll 418 can absorb the heat in the high-temperature part of the pressurizing roll 414 and moves the heat to the low-temperature part. Thus, the temperature distribution in the axial direction becomes small and the temperature of the pressurizing roll 414 and the temperature of the heat belt 401 can be prevented from exceeding a predetermined temperature.

Further, the fusing device has the elastic layer 411 on the heating belt 401 side in the nip part 415 so that the elastic layer 411 sandwiches the heating belt 401 having a thickness of 65 μm. Thus, the effect of wrapping and fixing toner upon the fixing can be obtained and good color image quality can be provided.

Further, in order to provide better color image quality, an elastic layer made of silicone rubber, etc., having a thickness of several 10 μm may be provided between the conductive layer 403 and the surface mold release layer 404 of the heating roll 401.

In the fourth to sixth embodiments, the examples of using either or both of the magnetic core or/and the magnetic field shield member of the invention with the fusing device in the electrophotographic apparatus have been given. However, the electrophotographic apparatus of the invention is not limited to these configurations described above in the examples, and the configuration can be changed or added in various manners based on the known findings so long as the configuration of the invention is contained.

For example, change can be made in such a manner that the pressurizing roll as the pressurizing rotation body in the fourth or fifth embodiment is changed to an endless belt pressurizing member (pressurizing belt) to form a roll-belt nip type fusing device or that the pressurizing roll as the pressurizing rotation body in the sixth embodiment is changed to an endless belt pressurizing member (pressurizing belt) to form a belt-belt nip type fusing device.

The configurations in the embodiments can also be used in combination as desired. For example, the metal roll placed for the pressurizing roll in the sixth embodiment can also be placed for the pressurizing roll in the fourth or fifth embodiment.

Further, in the fourth to sixth embodiments, the configurations in which only the fixing rotation body is heated are taken as examples. However, the pressurizing rotation body may be heated preliminarily. The heating method at this time may be heating with a heat source such as a general halogen lamp or may be the electromagnetic induction heating method. When adopting the electromagnetic induction heating method, of course, the magnetic core and the magnetic field shield member of the invention can be applied, in which case even if the magnetic core or the magnetic field shield member of the invention is not applied to the fixing rotation body, the electrophotographic apparatus can be defined as the electrophotographic apparatus of the invention.

In the embodiments, three examples in which either or both of the magnetic core or/and the magnetic field shield member of the invention are placed are given. In the examples, the electrophotographic apparatus of the invention may have only either of the magnetic core or the magnetic field shield member of the invention, and placing both of the magnetic core and the magnetic field shield member of the invention is not nessarily required for the electrophotographic apparatus of the invention.

[Seventh Embodiment]

Last, a seventh embodiment concerning an electrophotographic apparatus adopting so-called transfer and fixing simultaneous technique in which an inductance element adopting a magnetic core of the invention is used and a magnetic field shield member of the invention capable of providing a function for suppressing an electromagnetic field leakage is applied to electromagnetic shielding of a transfer and fuser device will be discussed.

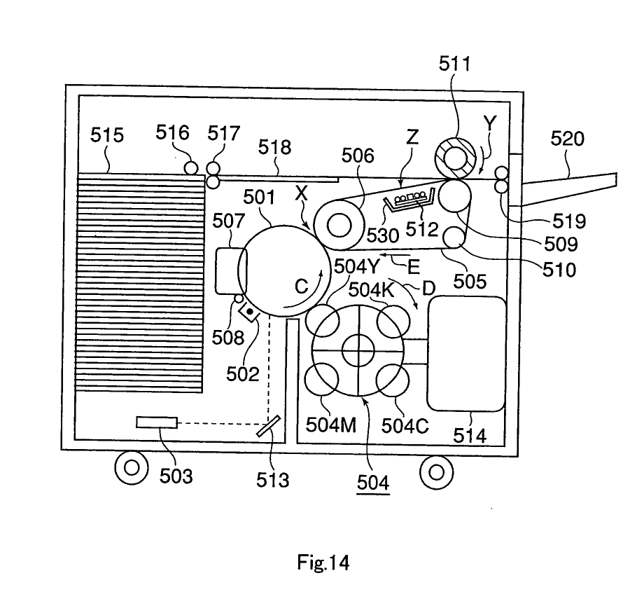

FIG. 14 is a schematic drawing showing the configuration of an electrophotographic apparatus of the seventh embodiment of the invention.

The electrophotographic apparatus mainly has an image bearing rotation body, an image formation part, a transfer and fixing section including a heating member and a pressurizing member.

In the embodiment, the image bearing rotation body is an intermediate transfer belt 505 having a circumferential surface on which an unfixed toner image is formed by the image formation part and is taken up by a primary transfer roll 506, a tension roll 509, and a drive roll 510. In the embodiment, an endless belt body is used as the image bearing rotation body, but a roll-like body may be used.

The image formation part has a photoconductive drum 501 on a surface of which a latent image is formed due to the electrostatic potential difference. Around the photoconductive drum 501, the image formation unit has a charger 502 for almost uniformly charging the surface of the photoconductive drum 501, a light exposure section having an exposure device (a laser scanner) 503 for irradiating laser light corresponding to each color signal to the photoconductive 501 to form a latent image, a mirror 513, etc., a rotation-type developing device 504 storing four color toners of cyan, magenta, yellow, and black to visualize the latent image on the surface of the photoconductive drum 501 by the color toners to form an unfixed toner image, the above-mentioned primary transfer roll 506 disposed to face the photoconductive drum 501 while the intermediate transfer belt 505 is disposed therebetween, transferring the unfixed toner image on the surface of the photoconductive drum 501 to the intermediate transfer belt 505, a cleaning device 507 for cleaning the surface of the photoconductive drum 501 after transfer, and an deelectrifing lamp 508 for deelectrifying the surface of the photoconductive drum 501.

The transfer and fixing section has the above-mentioned tension roll 509 disposed so as to take up the intermediate transfer belt 505 thereon together with the primary transfer roll 506 and the drive roll 510, and a pressurizing roll 511 which is a pressurizing member disposed to face the tension roll 509 so as to sandwich the intermediate transfer belt 505 therebetween, and a nip part is formed between the intermediate transfer belt 505 and the pressurizing member.

The electrophotographic apparatus further has a paper feed roll 516 for transporting paper (record media) stored in a paper feed unit 515 one sheet at a time, a registration roll 517, and a transport guide 518 for supplying paper to the nip between the intermediate transfer belt 505 wound around the tension roll 509 and the pressurizing roll 511.

The electrophotographic apparatus of the embodiment of the invention is characterized in that the electrophotographic apparatus has a magnetic field generation member 512 for heating the toner image from the back side of the intermediate transfer belt 505 and a magnetic field shield member 530 shaped so as to surround the magnetic field generation member 512, the magnetic field generation member 512 and the magnetic field shield member 530 disposed within the circumference of the intermediate transfer belt 505 and in the upstream in relation to the opposed position to the pressurizing roll 511 in the circumferential rotation direction (nip part).

The photoconductive drum 501 has an OPC (organic photoconductive layer) or a photoconductor layer made of a-Si, etc., on the surface of a cylindrical conductive base material electrically grounded. The developing device 504 has four developing devices 504C, 504M, 504Y, and 504K storing cyan, magenta, yellow, and black toners, respectively, and is supported to be rotatable so that the developing devices can be opposed to the photoconductive drum 501. Each developing device contains a developing roll for forming a toner layer on the surface thereof and transporting the toner layer to the position opposed to the photoconductive drum 501. A voltage having 400V of DC voltage superposed on a rectangular wave alternating voltage having an alternating voltage value V_{P.P} of 2 kV and a frequency f of 2 kHz is applied to the developing roll and the toner is transferred to the latent image on the surface of the photoconductive drum 501 by the action of an electric field. The developing devices 504C, 504M, 504Y, and 504K are replenished with toners from a toner hopper 514.

The intermediate transfer belt 505 has at least a conductive layer and a surface mold release layer deposited in order on the surface of a base material layer. It is similar in detail to the heating belt 401 in the sixth embodiment and will not be discussed again in detail.

Since the intermediate transfer belt 505 is driven by the drive roll 510 and is circumferentially moved, the intermediate transfer belt 505 is moved at the same speed as the inserted record medium with rotation of the drive roll 510 at the press contact part between the intermediate transfer belt 505 and the pressurizing roll 511, namely, the nip part. At this time, the nip width and the record medium moving speed are set so that the time during which the record medium exists in the nip part (nip time) becomes in a range of from 10 ms to 50 ms or more. This nip time, namely, the time interval between the instant at which fused toner is pressed against the record medium and the instant at which the record medium is peeled off from the intermediate transfer belt 505 is not less than 50 ms as mentioned above, so that if the toner is heated to sufficient temperature to deposit the toner on the record medium, the toner temperature is lowered to such an extent that no offset occurs at the exit of the nip.

The magnetic field generation member 512 in the embodiment is lineary formed as a whole, while the magnetic field generation member 150 in the sixth embodiment is formed like a curve along the shape of the heating belt 401 placed in the proximity of the magnetic field generation member 150. However, they are the same except the shape. That is, as a magnetic core, the magnetic core of the invention is used. The detailed description is the same as that in the sixth embodiment and therefore will not be made again.

The heating principle of the magnetic field generation member 512 and the intermediate transfer belt 505 is also similar to that of the magnetic field generation member 420 and the heating belt 401 in the sixth embodiment.

In the seventh embodiment, the magnetic core in the magnetic field generation member 512 has a structure where magnetic particles are arranged in a base material under a dispersed state, so that the shape of the magnetic core can be freely changed and can be easily formed to a required size and shape. Therefore, by applying this structure to the magnetic core, the flexibility of design of the magnetic field generation member 512 is increased. Also, in the fusing device of the embodiment, the magnetic core contributes to heat generation and therefore the magnetic core itself is exposed to a high temperature, although a solidified hydraulic composition is used as the base material constituting the magnetic core and therefore it is possible to impart a sufficient heat resistance property against the generated heat to the magnetic core.

Further, the magnetic particles are used, whereby the magnetic particle itself has adequate electric resistance and thus the self-heating problem caused by so-called induction heating is extremely small even in a high frequency band and therefore the loss is small and the effective magnetic permeability can be enhanced even in the high frequency band.

Meanwhile, the magnetic field shield member 530 in the embodiment is a cover-like member placed in the proximity of the magnetic field generation member 512 so as to cover the magnetic field generation member 512 and has a structure in which magnetic particles are arranged in a base material under a dispersed state. In the embodiment, the magnetic field shield member 530 has a ship-like cross section so as to surround the magnetic field generation member 512. Other specific configurations of the magnetic field shield member 530 are the same as those in the fifth embodiment.

A member, in which magnetic particles are arranged in a base material under a dispersed state, is used as the magnetic field shield member in the embodiment as described above, so that the magnetic field shield member can be easily molded to any of various shapes and can be easily manufactured. Therefore, the performance of the electrophotographic apparatus can be enhanced easily and at low cost without inhibiting miniaturization of the parts. Also, in the fusing device of the this embodiment, a magnetic field generation member existing in the proximity of the magnetic field shield member contributes to heat generation and therefore the magnetic field shield member itself is exposed to a high temperature, although a solidified hydraulic composition is used as the base material constituting the magnetic field shield member and therefore it is possible to impart a sufficient heat resistant property against the generated heat to the magnetic field shield member.

The operation of the described electrophotographic apparatus is as follows: The photoconductive drum 501 is rotated in the arrow C direction shown in FIG. 14 and is charged almost uniformly by the charger 502 and then is irradiated with laser light subjected to pulse width modulation in accordance with a yellow image signal of an original from the laser scanner 503 to form an electrostatic latent image corresponding to a yellow image on the photoconductive drum 501. The electrostatic latent image for the yellow image is developed by the yellow developing device 504Y previously placed at the developing position by the developing device 504 to form a yellow unfixed toner image on the photoconductive drum 501.

The yellow unfixed toner image is electrostatically transferred by the action of the primary transfer roll 506 onto the circumferential surface of the intermediate transfer belt 505 circumferentially moving at the same line speed (process speed) as the rotation speed of the photoconductive drum 501 in the arrow C direction at a primary transfer part X, which is an abutment part between the photoconductive drum 501 and the intermediate transfer belt 505. The intermediate transfer belt 505 on which the yellow unfixed toner image is formed is once circumferentially moved in the opposite direction to the arrow C direction with the yellow unfixed toner image held on the surface of the intermediate transfer belt 505 and is placed at a position where a magenta image is to be deposited on the yellow unfixed toner image for transfer.

On the other hand, after the surface of the photoconductive drum 501 is cleaned by the cleaning device 507, the photoconductive drum 501 is again charged almost uniformly by the charger 502 and is irradiated with laser light from the laser scanner 503 in accordance with a magenta image signal.

While an electrostatic latent image for the magenta image is formed on the photoconductive drum 501, the developing device 504 is rotated in the arrow D direction for placing the magenta developing device 504M at the developing position to develop the electrostatic latent image by magenta toner. A magenta unfixed toner image thus formed is electrostatically transferred onto the circumferential surface of the intermediate transfer belt 505 in the primary transfer part X and is deposited on the yellow unfixed toner image.

Subsequently, the described process is executed for cyan and black. At the termination of transferring and depositing four color toner images on the surface of the intermediate transfer belt 505 or while the last color (black) is being transferred, paper (record medium) stored in the paper feed unit 515 is fed by the paper feed roll 516 and is transported via the registration roll 517 and the transport guide 518 to a secondary transfer part Y of the intermediate transfer belt 505.

On the other hand, the four-color unfixed toner image formed on the circumferential surface of the intermediate transfer belt 505 is passed through a heating area Z opposed to the magnetic field generation member 512 in the upstream in relation to the secondary transfer part Y. In the heating area Z, the conductive layer of the intermediate transfer belt 505 generates heat upon electromagnetic induction heating by the action of a magnetic field generated by the magnetic field generation member 512. Accordingly, the conductive layer is rapidly heated and the heat is propagated to the surface mold release layer with the passage of time. When the unfixed toner image on the circumferential surface of the intermediate transfer belt 505 arrives at the secondary transfer part Y, the unfixed toner image on the circumferential surface of the intermediate transfer belt 505 is fused.

The toner of the unfixed toner image fused on the circumferential surface of the intermediate transfer belt 505 is brought into intimate contact with paper by pressure of the pressurizing roll 511, which presses in agreement with transporting of the paper in the secondary transfer part Y. In the heating area Z, the intermediate transfer belt 505 is heated locally only in the surface proximity and the fused toner comes in contact with the paper having the same temperature as the room temperature and is rapidly cooled. That is, when the fused toner passes through the nip part of the secondary transfer part Y, the fused toner instantaneously penetrates the paper and is transferred and fixed by the heat energy and the press contact force, which the toner has, and the paper is transported to the exit of the nip part while the paper is drawing the heat from the toner and the intermediate transfer belt 505 heated only in the surface proximity. At this time, the nip width and the moving speed of the record medium are set appropriately, so that the temperature of the toner at the exit of the nip part becomes lower than the softening point temperature. Thus, the cohesive force of the toner grows and the toner image is almost completely transferred and fixed to the paper surface without producing offset. After this, the paper on to which the toner image is transferred and fixed is ejected through an ejection roll 219 onto an ejection tray 520. The full-color image formation is now complete.

As described above, in the electrophotographic apparatus of the invention, only the proximity of the conductive layer of the intermediate transfer belt 505 absorbing the electromagnetic wave is heated in the heating area Z opposed to the magnetic field generation member 512 and the toner heated and fused in the heating area Z is brought into press contact with the paper having the same temperature as the room temperature at the secondary transfer part Y, whereby the toner is transferred and fixed at the same time. Since only the surface of the intermediate transfer belt 505 is heated, the temperature of the intermediate transfer belt 505 is lowered rapidly after the transfer and fixing. Thus, accumulation of heat in the electrophotographic apparatus is extremely lessened.

On the other hand, if the electrophotographic apparatus in the related art adopting the transfer and fixing simultaneous technique is used continuously, accumulation of heat occurs and a rise in the apparatus temperature accompanying the continuous use of the apparatus becomes noticeable and the potential characteristic of the photoconductive drum becomes unstable. In particular, lowering of the charge potential becomes noticeable and if reverse development is used, for example, as a toner image formation method, back-ground fogging occurs in a background portion and degradation of the image quality becomes noticeable. Further, as the apparatus temperature rises, toner is fused in the vicinity of the developing device and is firmly fixed onto a cleaning blade, etc. In contrast, when the electrophotographic apparatus of the embodiment is used continuously, the rise in the apparatus temperature is smaller by far than that in the apparatus in the related art, and the characteristics of the photoconductive drum, toner, etc. do not change. Thus, even if the apparatus is used for a long time, the image quality degradation is scarcely observed and high-quality images can be provided stably. This advantage is particularly noticeable in forming a color image.

Accordingly, the electrophotographic apparatus of the embodiment has the following specific advantages: Since the proximity of the surface of the intermediate transfer belt is directly heated by the magnetic field generation member, rapid heating can be accomplished independently of the thermal conductivity or the heat capacity of the base material of the intermediate transfer belt. Since the transfer efficiency is independent of the thickness of the intermediate transfer belt, when the rigidity of the intermediate transfer belt needs to be enhanced to achieve speed-up, even if the base layer (base material) of the intermediate transfer belt is thickened, the toner can be promptly heated to the fixing temperature.

The base layer of the intermediate transfer belt generally has a resin having low thermal conductivity and thus is good in heat insulation and if continuous print is executed, the heat loss is small. If an area in which no image exists, for example, a non-image forming area between continuously fed paper sheets is passed through the heating area Z, the excitation circuit can also be controlled to stop fruitless heating. Accordingly, the energy efficiency becomes very high. As the heat efficiency is enhanced, the temperature rise in the electrophotographic apparatus can also be suppressed accordingly and the characteristic change of the photoconductive drum, adherence of toner onto the cleaning member, etc., can also be prevented.

Incidentally, in the embodiment, the example is shown in which after all four color unfixed toner images are transferred to the circumferential surface of the intermediate transfer belt, the electromagnetic induction heating is executed by the magnetic field generation member to heat and fuse the toner. However, after one color toner image is primarily transferred at a time, the toner may be heated and fused and be temporarily fixed onto the circumferential surface of the intermediate transfer belt. Such a method makes it possible to prevent disordering of four color superposed toner images and match the images in registration and magnification with good accuracy.

In the embodiment, the electrostatic transfer method using a bias application roll having an insulating dielectric layer for electrostatically transferring the unfixed toner image onto the intermediate transfer belt is adopted as the transfer method in the primary transfer part X. However, adhesion transfer in which a heat resisting intermediate transfer belt having elasticity is provided and a primary transfer roll presses against a photoconductive drum from the inside of the intermediate transfer belt to transfer an unfixed toner image onto the circumferential surface of the intermediate transfer belt may be adopted. In this case, toner is somewhat left on the surface of the photoconductive drum after the transfer and thus it is desirable that the remaining toner should be deelectrified and cleaned by a deelectrifying device and a cleaning device.

In the seventh embodiment, the example of using the magnetic core and the magnetic field shield member of the invention for the fusing device in the electrophotographic apparatus has been given. However, the electrophotographic apparatus of the invention is not limited to the configuration in the embodiment and the configuration can be changed or added in various manners based on the known findings so long as the configuration of the invention is contained.

For example, in the embodiment, the intermediate transfer belt of an endless belt type is used as the image bearing rotation body. However, a roll-like intermediate transfer roll or a photoconductor (roll-like or endless belt photoconductor) may be used as the image bearing rotation body. When using the image bearing rotation body as a photoconductor, the above-described developing devices correspond to the image formation device in the invention. However, since the photoconductor itself is heated by electromagnetic induction heating, the photoconductor and the image formation system both having the heat resistance are required.

In the embodiment, the intermediate transfer belt 505 is heated only by electromagnetic induction heating in the heating area Z, but the tension roll 509 may be a heating member used auxiliarily or mainly as a heating source for transferring and fixing. In this case, if heating of the tension roll 509 has a sufficient heat quantity as the heating source for transferring and fixing, the electromagnetic induction heating in the heating area Z may be skipped. As the heating method of the tension roll 509, a heat source such as a halogen lamp known as a fixing roll is placed in the tension roll 509 or the electromagnetic induction heating technique may be adopted as with the heating roll in the third or fourth embodiment. In this case, of course, the magnetic core and/or the magnetic field shield member of the invention can be used.

Also, each of the configurations shown in the fourth to sixth embodiments can be incorporated to the seventh embodiment whenever necessary. Further, the seventh embodiment has been discussed by citing a solidified hydraulic composition as an example of the base material of the magnetic core and the magnetic field shield member, although the invention is not limited to this and a well-known resin material or the like may be used instead. As a matter of course, it is preferable that a solidified hydraulic composition is used as the base material from the viewpoint of heat resistance property, low cost, formability, and the like.

In the embodiment, although examples of both of placement of the magnetic core and the magnetic field shield member are given, the electrophotographic apparatus of the invention may have only either of the magnetic core or the magnetic field shield member of the invention, and placing both of the magnetic core and the magnetic field shield member of the invention is not required for the electrophotographic apparatus of the invention.

As described above, in the first to seventh embodiments, the shape of a member, on which electromagnetism acts, can be changed as desired using a material in which magnetic particles are arranged in a base material under a dispersed state, so that the member can be easily formed to a required size. Also, the magnetic particles are uniformly dispersed in the base material, so that a homogeneous magnetic core or magnetic field shield member can be obtained in which there occurs no variation in magnetic characteristic depending on positions. Further, when a solidified hydraulic composition is used as the base material, the heat resistance property of the material including the magnetic particles becomes extremely high, so that if the invention is applied to the magnetic core or magnetic field shield member of an excitation coil in an electromagnetic induction heating apparatus, a particularly stabilized characteristic is obtained and it becomes unnecessary to give consideration to influences of heat. As a result, there is increased the flexibility of design concerning the shape and layout.

While the first to seventh embodiments of the invention have been described, such description is for illustrative purposes only, and it is to be understood that the dimensions, the shapes, the placement, the characteristics, the compositions, the conditions, etc., (including the specific numeric values thereof) specified in the apparatus configurations do not limit the invention and that those skilled in the art can appropriately select the optimum ones in response to various conditions.

As described above, according to the invention, a member, in which magnetic particles are arranged in a solidified hydraulic composition under a dispersed state, is used as the magnetic core, so that the magnetic core can be easily molded to any of various shapes and can be easily manufactured. Also, by installing the magnetic core only in a part of an inductance element such as an excitation coil or a transformer, the inductance can be flexibly designed over a wide range. Further, the loss is small and the effective magnetic permeability can be enhanced even in a high frequency band.

Also, according to the invention, magnetic particles that are the main material of a magnetic core are arranged in a base material under a dispersed state and are maintained under a particle state, so that occurrence of an eddy current in the magnetic core can be canceled. Thus, the heat loss due to the eddy current can be canceled.

Further, the magnetic field shield member of the invention made of a material, in which magnetic particles are arranged in a base material under a dispersed state, is disposed so as to surround a magnetic field generation member for generating a magnetic field, whereby the leakage of an electromagnetic field can be suppressed, the shape can be worked as desired, and the flexibility of parts design can be enhanced. In particular, when a solidified hydraulic composition is used as the base material, it becomes possible to secure a high heat resistance property of an obtained magnetic core or magnetic field shield member. Also, it becomes possible to increase the mixing ratio of the magnetic particles, so that the magnetic permeability can be still further enhanced.

With the excitation coil, transformer, and electric equipment of the invention that use the magnetic core and/or the magnetic field shield member of the invention having the superior effects described above, the effects realized by the adopted magnetic core and/or magnetic field shield member of the invention can be given to the excitation coil, transformer, and electric equipment, as a matter of course. Also, the flexibility of design of the excitation coil, transformer, and electric equipment itself can be largely enhanced.

On the other hand, according to the invention, in the electrophotographic apparatus adopting the electromagnetic induction heating technique for fixing or transferring and fixing, the magnetic core suppressing the eddy current loss and having high flexibility in shape is used in the magnetic field generation member, so that still more energy saving can be accomplished at low cost, the flexibility in designing the electrophotographic apparatus can be expanded, and further the electrophotographic apparatus can be still more miniaturized.

According to the invention, in the electrophotographic apparatus adopting the electromagnetic induction heating technique for fixing or transferring and fixing, magnetic field leakage from the magnetic field generation member can be shielded effectively.

What is claimed is:

1. A magnetic core provided so as to be related to at least a part of a magnetic field generation means, wherein a material, in which magnetic particles are arranged in a base material under a dispersed state, is used as a magnetic material acting on an electromagnetic characteristic of a generated magnetic field.

2. A magnetic core according to claim 1, wherein the magnetic particle is at least one of iron powder, ferrite powder, and magnetite powder.

3. A magnetic core according to claim 2, wherein the base material is a solidified hydraulic composition.

4. A magnetic core according to claim 1, wherein the base material is a solidified hydraulic composition.

5. A magnetic core according to claim 4, wherein the hydraulic composition is one of portland cement and a high-density hydrothermal synthetic ceramics precursor.

6. An excitation coil comprising the magnetic core according to claim 1, wherein the magnetic core is placed on the periphery of the coil serving as the magnetic field generation means.

7. A transformer obtained by winding at least two coils at different positions of one magnetic core,
wherein the one magnetic core is the magnetic core according to claim 1.

8. An electric equipment comprising at least a magnetic field generation means, wherein the magnetic core according to claim 1 is provided so as to be related to at least a part of the magnetic field generation means.

9. An electrophotographic apparatus comprising:
an image formation means for forming an unfixed toner image on a surface of a record medium by using electrophotography; and
a fusing means having a fixing rotation body and a pressurizing rotation body disposed to press against the fixing rotation body to define a nip part therebetween, fixing the unfixed toner image on the surface of the record medium by inserting the record medium into the nip part so that the surface on which the unfixed toner image is formed contacts with the fixing rotation body,
wherein a conductive layer is formed in the proximity of a circumferential surface of one of the fixing rotation body and the pressurizing rotation body;
wherein a magnetic field generation means is placed close to one of the fixing rotation body and the pressurizing rotation body to which the conductive layer is formed; and
wherein the magnetic field generation means has the magnetic core according to claim 1.

10. An electrophotographic apparatus comprising:
an image bearing rotation body;
an image formation means for forming an unfixed toner image on a circumferential surface of the image bearing rotation body by using electrophotography; and
a pressurizing member disposed to face the image bearing rotation body to define a nip part therebetween,
in which a record medium is inserted into the nip part, whereby the unfixed toner image is transferred and fixed onto a surface of the record medium by application of heat and pressure,
wherein a conductive layer is formed in the proximity of the circumferential surface of the image bearing rotation body;
wherein a magnetic field generation means is disposed close to the image bearing rotation body in the nip part and upstream thereof of the image bearing rotation body; and
wherein the magnetic field generation means has the magnetic core according to claim 1.

11. An electrophotographic apparatus comprising:
an image bearing rotation body;
an image formation means for forming an unfixed toner image on a circumferential surface of the image bearing rotation body by using electrophotography;
a heating member disposed in the image bearing rotation body to abut against the image bearing rotation body in the circumference thereof, and provided for heating the image bearing rotation body;
a pressurizing member disposed to face the heating member through the image bearing rotation body to define a nip part with the image bearing rotation body,
in which a record medium is inserted into the nip part, whereby the unfixed toner image is transferred and fixed onto a surface of the record medium by application of heat and pressure,
wherein a conductive layer is formed at least in one of the proximity of the circumferential surface of the image bearing rotation body and the proximity of an abutment part of the heating member against the image bearing rotation body;
wherein when the conductive layer is formed in the image bearing rotation body, a magnetic field generation means is disposed close to the image bearing rotation body in the nip part and upstream thereof of the image bearing member;
wherein when the conductive layer is formed in the heating member, the magnetic field generation means is disposed close to the heating member; and
wherein the magnetic field generation means has the magnetic core according to claim 1.

12. A magnetic field shield member provided on the periphery of a magnetic field generation means for generating a magnetic field and shielding the magnetic field generated by the magnetic field generation means, wherein magnetic particles are arranged in a base material under a dispersed state.

13. A magnetic field shield member according to claim 12, wherein the magnetic particle is at least one of iron powder, ferrite powder, and magnetite powder.

14. A magnetic field shield member according to claim 13, wherein the base material is a solidified hydraulic composition.

15. A magnetic field shield member according to claim 12, wherein the base material is a solidified hydraulic composition.

16. A magnetic field shield member according to claim 15, wherein the hydraulic composition is one of portland cement and a high-density hydrothermal synthetic ceramics precursor.

17. An excitation coil comprising the magnetic field shield member according to claim 12, wherein the magnetic field shield member is placed on the periphery of the coil serving as the magnetic field generation means.

18. A transformer obtained by winding at least two coils at different positions of one magnetic core,
wherein the magnetic field shield member according to claim 12 is provided on the periphery of at least one of the coils.

19. An electric equipment comprising at least a magnetic field generation means, wherein the magnetic field shield member according to claim 12 is provided on the periphery of the magnetic field generation means.

20. An electrophotographic apparatus comprising:
an image formation means for forming an unfixed toner image on a surface of a record medium by using electrophotography; and
a fusing means having a fixing rotation body and a pressurizing rotation body disposed to abut against the fixing rotation body to define a nip part therebetween, fixing the unfixed toner image on the surface of the record medium by inserting the record medium into the nip part so that the surface on which the unfixed toner image is formed contacts with the fixing rotation body,
wherein a conductive layer is formed in the proximity of a circumferential surface of one of the fixing rotation body and the pressurizing rotation body;
wherein a magnetic field generation means is placed close to the one of the fixing rotation body and the pressurizing rotation body;
wherein a leakage magnetic field shielding member for shielding at least a part of a leakage magnetic field, which does not affect the conductive layer, of the magnetic field generated from the magnetic field generation means is disposed in the periphery of the magnetic field generation means; and
wherein the magnetic field shield member is the magnetic field shield member according to claim 12.

21. An electrophotographic apparatus comprising:
an image bearing rotation body;
an image formation means for forming an unfixed toner image on a circumferential surface of the image bearing rotation body by using electrophotography; and
a pressurizing member disposed to face the image bearing rotation body to define a nip part therebetween,
in which a record medium is inserted into the nip part, whereby the unfixed toner image is transferred and fixed onto a surface of the record medium by application of heat and pressure,
a magnetic field generation means for generating a magnetic field;
wherein a conductive layer is formed in the proximity of the circumferential surface of the image bearing rotation body;
wherein a magnetic field generation means is disposed close to the image bearing rotation body in the nip part and upstream thereof of the image bearing rotation body;
wherein a leakage magnetic field shielding member for shielding at least a part of a leakage magnetic field, which does not affect the conductive layer, of the magnetic field generated from the magnetic field generation means is disposed in the periphery of the magnetic field shield member; and
wherein the magnetic field shield member is the magnetic field shield member according to claim 12.

22. An electrophotographic apparatus comprising:
an image bearing rotation body;
an image formation means for forming an unfixed toner image on a circumferential surface of the image bearing rotation body by using electrophotography;
a heating member disposed in the image bearing rotation body to abut against the image bearing rotation body in the circumference thereof, and provided for heating the image bearing rotation body; and
a pressurizing member disposed to face the heating member through the image bearing rotation body to define a nip part with the image bearing rotation body,
in which a record medium is inserted into the nip part, whereby the unfixed toner image is transferred and fixed onto a surface of the record medium by heat and pressure,
wherein a conductive layer is formed at least in one of the proximity of the circumferential surface of the image bearing rotation body and the proximity of the abutment part of the heating member against the image bearing rotation body;
wherein when the conductive layer is formed in the image bearing rotation body, the magnetic field generation means is disposed close to the image bearing rotation body in the nip part and upstream thereof of the image bearing member;
wherein when the conductive layer is formed in the heating member, the magnetic field generation means is disposed close to the heating means;
wherein a leakage magnetic field shielding member for shielding at least a part of a leakage magnetic field, which does not affect the conductive layer, of the magnetic field generated from the magnetic field generation means is disposed in the periphery of the magnetic field generation means; and
wherein the magnetic field shielding member is the magnetic field shielding member according to claim 12.
